(19) United States
(12) Patent Application Publication
(10) Pub. No.: US 2022/0148262 A1
(43) Pub. Date: May 12, 2022

(54) METHOD FOR GENERATING GEOMETRIC DATA FOR A PERSONALIZED SPECTACLES FRAME

(71) Applicant: YOU MAWO GmbH, Konstanz (DE)

(72) Inventors: Daniel Szabo, Darmstadt (DE); Dominik Kolb, Reichenau (DE)

(21) Appl. No.: 17/312,549

(22) PCT Filed: Dec. 5, 2019
(86) PCT No.: PCT/DE2019/000316

§ 371 Date: Jan. 17, 2022

(30) Foreign Application Priority Data
Dec. 13, 2018 (DE) 10 2018 009 811.8

(51) Int. Cl. G06T 17/20; G06T 19/20

(52) U.S. Cl. CPC G06T 17/20; G06T 2219/2021; G06T 19/20

(57) ABSTRACT

A method for generating geometric data for a personalized object includes providing a polygonal model for the object, the polygonal model including a mesh formed by mesh elements that are separate points, edges and surfaces which represent a basic geometric shape of the object. The polygonal model has local attributes which are assigned to at least some of the mesh elements. A set of predefined tools for adaptation is also provided for deforming a region of the mesh of the polygonal model. The tools for adaptation are defined such that, when used on the mesh, a topology of the mesh remains, and that, when used, the local attributes of the mesh elements of the region are evaluated to determine a measurement of a local deformation. The polygonal model is then adapted by using the tools for adaptation.

### CROSS-REFERENCE TO RELATED APPLICATIONS

This application is a national phase entry of, and claims priority to, International Application No. PCT/DE2019/000316, filed Dec. 5, 2019, which claimed priority to German Patent Application No. DE 10 2018 009 811.8, filed on Dec. 13, 2018, the entire contents of which are herein incorporated by reference.

### TECHNICAL FIELD

This application relates to a method for generating geometric data of a personalized object, such as for further processing into manufacturing data for the manufacture of the object. In one example, the object may be a spectacles frame.

### BACKGROUND

Methods for the personalized, made to measure, modeling of objects, such as for example spectacles frames, and for the manufacture of such objects by additive manufacturing methods are known in principle.

For example, U.S. Pat. No. 9,810,927 (3-D Frame Solutions) describes a method of generating a product specification for a customized spectacles frame. In this context, a library of fully parameterized standard models is accessed. The models can be adapted using fitting values which comprise biometric data of the future wearer. Finally, the adapted model is used to generate the product specification for the manufacture, for example by a 3D printer.

French Patent No. FR 3 044 430 (AK Optique) discloses a method of manufacturing a spectacles frame with flat nose pads. In this context, spatial data of the face of the future wearer are first collected, a three-dimensional model of the spectacles frame is generated on the basis of this, and finally the frame is manufactured by an additive manufacturing method. In the course of the generation of the three-dimensional model, this is reconciled with a three-dimensional model of the face so that flattened areas can be generated as nose pads at the correct position.

In these known methods, the scope for adaptations that can be made is very limited. Once the spatial data have been acquired, it is not possible for the future wearer to influence the design of the spectacles to be made.

U.S. Pat. No. 9,470,911 (Bespoke, Inc.) relates to systems and methods for the manufacture of made to measure products. For this purpose, an anatomical model of the user is first created on the basis of a scan and/or measurement data. A computer provides a product model which can be adapted, and allows for a preview, as well as an automatic or user-controlled adaptation of the product model. Finally, the model can be transmitted to a manufacturer. The product model may be represented by a surface grid or a solid model that has elements or features that comprise, for example, polygons, curved elements, or the like.

No further details are disclosed about the specific structure of the product model and the modifications made thereto in the customization process.

US Patent Application Publication No. 2015/0127132 (West Coast Vision Labs Inc.) describes a system and method for the manufacture of spectacles frames made to measure, wherein the geometry generated can be used for modeling, fabricating, and printing. In order to determine the geometry, a template with predetermined dimensions is used as a starting point. These can then be adapted on the basis of multi-dimensional data of the wearer's head and several identified orientation points of this data. The geometry is represented by a polygon model. The adapting is done by a morphing process.

The design of the spectacles frame is essentially known at the start of the process. The adaptations made relate to the fit of the pair of spectacles to the head of the wearer.

US Patent Application Publication No. 2017/0038767 (Materialise N. V.) relates to the adaptation of the geometry of objects, for example spectacles frames or wristwatches, that are produced by 3D printing techniques. The adaptation by the users is performed within limits that are set by the manufacturers. In particular, these limits may be the result of factors that relate to the ability to print a customized geometry. The tools for adaptation are adapted to the object to be manufactured. For this purpose, customizable zones are defined within the framework of the base model, and graphical control elements (for example sliding bars) are assigned to the corresponding customizations.

Within the scope of the design of a base model, the corresponding customization options are thus defined. Thus, in addition to the actual product design, the designer must always identify and implement the possible customizations as well. This generates an additional workload and requires additional knowledge and skills or the involvement of a specialist in case more complex adaptations are to be made possible.

### SUMMARY

It would therefore be desirable to create a method, belonging to the technical field mentioned above, for generating geometric data of a personalized object, which method makes the simple generation of new designs of the personalized object possible, the object being able to be adapted parametrically in a flexible manner.

To address these and other problems with the conventional designs, a first embodiment of the invention provides a method for generating geometric data of a personalized object that includes the following steps:

a) providing a polygon model for the object, wherein the polygon model comprises a mesh formed of mesh elements, wherein the mesh elements comprise discrete points, edges and faces that represent an initial geometric shape of the object; wherein the polygon model comprises local attributes that are associated with at least some of the mesh elements and relate to at least one association with one of a plurality of adaptation groups or parameters for a deformation process;

b) providing a set of predefined tools for adaptation for deforming a region of the mesh of the polygon model, wherein the tools for adaptation are defined such that, when they are being applied to the mesh, a topology of the mesh is preserved and that, when they are being applied, the local attributes of the mesh elements of the region are evaluated in order to determine a measure of a local deformation; and

c) adapting the polygon model by applying the tools for adaptation.

The method is a computer-assisted or computer-implemented method, which is made to be executed by appropriate software on suitable computers and machines. In accordance with this, in another embodiment, a computer program is provided that is adapted in such a way that it carries out the method in accordance with the embodiments of the invention, as well as a (non-volatile) storage medium comprising such a computer program. The computer program may include a plurality of modules which are executed on different devices which are geographically spaced apart and are connected to one another via a data network.

The polygon model represents the geometry of a physical product, in particular with regard to its manufacture after customization has taken place (made to measure manufacturing), for example by automated manufacturing methods (additive manufacturing, subtractive manufacturing). The adapted polygon model may also form a basis for semi-automated or manual manufacturing methods.

With the aid of the polygon model, the object is represented by a mesh of polygons formed by mesh elements. This means that the geometric shape of the object is approximated by a mesh of discrete elements consisting of points (nodes), edges and faces. These elements may represent the polygon model as such, or they may be derived directly and unambiguously from stored data.

Basic information such as position, orientation and adjacent neighboring elements are assigned to each individual element. In addition, further data fields are assigned to at least some of the mesh elements, which further data fields relate to at least one association with one of a plurality of adaptation groups or parameters for a deformation process. Thus, there may be mesh elements to which no local attributes are assigned, as well as those to which at least one local attribute is assigned. The assigned attribute may be the association with at least one of a plurality of adaptation groups or parameters for a deformation process or further attributes. A mesh element may be provided with attributes relating to the association as well as attributes relating to the deformation process. Preferably, a plurality of mesh elements are provided with attributes relating to the association and a plurality of mesh elements are provided with attributes relating to the deformation process, with both types of attributes being assigned to some of these mesh elements. In addition to the local attributes, there may also be global attributes, which relate to the polygon model as a whole.

The polygon model thus defines—including attributes—a parametric shape of the object the geometric data of which is to be generated.

Polygon models are known in particular from 3D computer graphics, such as those used, for example, in the context of computer game software for the real-time generation of animated graphic representations. Hardware components which support corresponding processing steps in a specific manner are commercially available (for example corresponding graphics chips).

When a polygon model is provided, this is initialized, i.e. the model parameters are set to predefined values.

To adapt the polygon model, adaptation steps from a set of predefined tools for adaptation are carried out. Defined functions correspond to the plurality of tools for adaptation provided in the set and the adaptation steps carried out with these, which functions compute the deformation of the polygon model for a desired parameter change. The changes in the polygon model and hence in the object geometry that are caused by the tools for adaptation are continuous. Preferably, the parameters of the tools for adaptation can be set with any desired degree of precision and not only in discrete steps. The topology of the polygon mesh is adapted to the subsequent procedures that modify the mesh, in particular to the deformations that are brought about by the tools for adaptation. Conversely, the tools for adaptation that act on certain regions of the object expect these to have a certain polygon topology structure.

For the calculation of the deformation, the position of the elements of the polygon mesh is read, deformed by the function and then stored again. For the calculation of the respective deformation, the attributes stored for each polygon mesh element (point, edge, face) are taken into account as well. The combination of the polygon model with local attributes and predefined tools for adaptation enables an allocation of the relation of model regions or model elements to deformation procedures to be achieved that is completely automated and controlled by data. This means that, apart from the definition of the tools for adaptation and certain local attributes, no explicit definition of the deformations of the object is required. The deformations result implicitly from the relation between already existing, semantically prepared object regions and the deformation procedures of the tools for adaptation linked to them via the attributes.

The model parameters are adapted proportionally to each other—except when a change in the overall shape is specifically to be brought about—in order to preserve the overall shape of the object as best as possible.

The topology of the mesh is preserved when the polygon model is being adapted with the aid of the associated predefined tools for adaptation. Here, the term “topology of a polygon model” is intended to be understood to mean the number and respective arrangement of the elements of the polygon mesh (nodes, edges, and faces). During the course of the adapting, subordinate changes are made to the shape, within the framework of the underlying base model. The polygon model is only deformed, elements are neither added nor removed. In accordance with this, only the position data of the elements of the polygon mesh need to be adapted. This considerably reduces the computational effort for the adaptation and enables an adaptation in real time to be achieved.

In addition, any geometric structures of the object (for example mounting holes, connecting elements, etc.) that interact with other elements must often have a precisely specified geometry, so that it makes little sense to adapt these elements within the framework of the adaptation process anyway. This would require the geometry of the structures to be included in the adaptation process as fixed, or that further adaptations would be necessary following the actual adaptation process in order to ensure the correct geometry of the structures for the purpose of the interaction. It is therefore simpler and more efficient to add such openings into the polygon mesh only after the individual adaptation has already been done. It is of advantage for the original mesh topology of the polygon model already to be prepared also with regard to such late adaptations with a change of topology.

The method in accordance with the invention is suitable for generating geometric data of various personalized objects, for example spectacles frames, hearing aid housings, shoes, wristwatches, insoles, prostheses, orthoses, etc.

By providing a polygon model on the one hand and, on the other hand, a set of predefined tools for adaptation that are adapted to this, a platform solution is made possible in which base models for certain types of objects can be provided within the framework of a design component. Each of these comprise a polygon model and the associated set of predefined tools for adaptation. Starting from a selected base model, a designer can create a product design without having to worry about the tools for adaptation. Thanks to the associated, unmodified tools for adaptation, the result is automatically available as an object which can be adapted in a parametric manner and which can therefore be used, without any further action, in an adaptation component of the platform for the customized adaptation. Once a base model with the associated tools for adaptation is defined, this can be used for a large number of designs of a given type of object. Designers can independently create product designs which can be changed in a parametric manner within the framework of the method in accordance with the invention.

Standardized interfaces and data formats are present between the design component and the adaptation component.

The geometric data can be further processed into manufacturing data for the manufacture of the object. The manufacturing data define the geometry of the customized object in accordance with the result of the adaptation process and, if applicable, of further elements of a product that comprises the object, in particular such further elements which can be manufactured in an automated manner. The manufacturing data are in particular intended for the subsequent additive manufacturing. However, in addition or as an alternative, the manufacturing data also comprise data that are intended for other types of manufacturing processes (for example CNC milling, grinding, etc.).

Additive manufacturing (3D printing, for example laser sintering) makes the automated production of shaped bodies made of different materials and, if necessary, with complex shapes, possible. Devices for additive manufacturing are available in various price ranges and of various levels of quality and can be operated in a decentralized manner. The prerequisites for their function are essentially access to the required manufacturing data and the provision of the required starting materials. In addition to the data that are required for the additive manufacturing (G-code), the manufacturing data may also include other data for other manufacturing steps. Thus, only a subset of the manufacturing data is required for the additive manufacturing.

For additive or subtractive manufacturing, the system may obtain data from the polygon model and/or refined polygon models derived therefrom according to formats that are standard in the industry for storing polygon meshes such as, for example, STL, OBJ or PLY. In addition to this, however, the system may advantageously generate and export spline curves and spline surfaces from the polygon model and/or from refined polygon models derived therefrom, which spline curves and spline surfaces are suitable for production systems that require such representation models for objects. In addition to this, it is also possible, in addition to the representation of the 3D model, to directly export instruction data sets for the manufacture of the 3D model, for example machine-specific G-code for the control of 3D printers or milling machines.

The various export options make it possible to produce personalized objects in different materials that require different production methods and therefore require different data exchange formats. For the production process, the manufacturing data are forwarded in a digital manner to the hardware that manufactures the object, in particular via a computer network (WAN or LAN). The system has interfaces in order to store the generated production data in a customer portal or to transmit them directly to the manufacturing partner via an appropriate program interface.

In addition, dimensioned technical drawings that document the adaptation process and which support the production process can preferably be output by the system in an automated manner.

The manufacturing data are based on the fully adapted polygon model. If they are used, within the framework of an interactive process, to output a physical prototype, for example for fitting by the end customer, they can be based on a partially adapted polygon model.

In order to provide the polygon model, the following steps are preferably carried out:

a1) providing a basic polygon model for an object type of the customized object, wherein local attributes are assigned to at least some mesh elements of the basic polygon model, which local attributes are indicative of an association with one of a plurality of adaptation groups;

a2) providing the set of predefined tools for adaptation associated with the basic polygon model for deforming the polygon model derived from the basic polygon model, wherein the tools for adaptation are adapted to the object type and at least some of the tools for adaptation evaluate the local attributes during their application, which local attributes are indicative of the association with the adaptation groups;

a3) modeling the basic polygon model in order to obtain the polygon model, wherein a topology of the basic polygon model remains unchanged, wherein the local attributes are modified as needed, wherein a set and definition of the plurality of adaptation groups is maintained.

In this way, the polygon model can be obtained, which forms the point of departure for the subsequent adaptation steps for generating the geometric data of the personalized object.

The basic polygon model represents a general template (blueprint) that has the basic topology of the object type. Accordingly, a possible basic polygon model for example for the object type “spectacles frame” has elements that represent two lens receptacles, a bridge connecting them, as well as end pieces arranged on the outside of the lens receptacles for attaching hinges for spectacles temples. A different base model is provided for a pair of spectacles having a double bridge. The mesh underlying the basic polygon model is optimized in such a way that it comprises a sufficient number of, but no unnecessary, points, edges, and faces in order to represent the conceivable geometries of the object in accordance with the object type and to cover all required deformations.

Local attributes are already assigned to mesh elements of the basic polygon model. These are also at least partially already initialized with input values, for example with semantic associations, namely to adaptation groups. The local attributes thus indicate, for example, to which functional component of an object certain partial regions of the geometry belong. This information can be used later in the adaptation process, for example in order to limit the effect of certain tools for adaptation to predetermined components of the object—as described in more detail below.

The aesthetic shaping and/or the adaptation process for this purpose of customizing the object follows only in the later step of modeling, after the tools for adaptation have been provided. Thus, for each object type (spectacles, implant, orthosis, prosthesis, shoe, etc.), only very few basic polygon models and associated sets of tools for adaptation are required.

The modeling can be carried out using common design tools and can be carried out, for example, by one skilled in the art (a designer). The design tools include, for example, procedures for automatically smoothing, distributing and aligning the existing polygon topology. In addition, tools may be provided within the framework of the method in accordance with the invention that are tailored to the requirements of the object type. These may be based on tools of the set of predefined tools for adaptation, or may be provided specifically for the modeling. In general, there are more degrees of freedom in the modeling than in the subsequent adaptation process for this purpose of customizing the object. A design of a polygon model, or the overall aesthetic impression of the corresponding object, once determined within the framework of the modeling, is thus substantially maintained also in the course of the subsequent adaptation process.

It is the intention that, in particular, an aesthetically pleasing and ergonomically advantageous shape is created by the modeling process. Through this step, a large number of product designs can be derived from a single basic polygon model. The associations of the mesh elements of the base model to adaptation groups, as well as any other local attributes, can, as a rule, be retained. They can also be taken into account already in the course of the modeling process if, for example, only one area of the three-dimensional shape is to be adapted. However, within the framework of the modeling process, local attributes can also be adapted or additional mesh elements can be provided with local attributes. For example, a desired rounding of an edge can be changed within the framework of the modeling process if a more rounded or a more angular shape is desired. The degree to which the local attributes can be modified, as well as the types of attributes that can be added, are determined in such a way that the tools for adaptation associated with the basic polygon model can work with the polygon models which are generated during the modeling process, i.e. that they can correctly interpret all attributes and take them into account during the course of their application to the polygon model. Thus, as a rule, the same set of tools for adaptation can be applied to any polygon model that is derived from the same basic polygon model. Thus, the designer does not need to worry about the tools for adaptation, but can instead focus on the actual design process.

During the modeling process, the designer works on the polygon mesh of the basic polygon model. If, within the framework of the method in accordance with the invention, the possibility of a virtual preview is given, this can also be used during the modeling process, so that the designer can check the result of all the adaptations that will later be made within the framework of the further steps of the method. Thus, he can also ensure in a simple manner that the adapted polygon models correspond to his ideas in terms of design and function.

The modeling process does not necessarily have to start from a basic polygon model; it can also be based on a polygon model which has already been modeled, because the topology of this polygon model corresponds to that of the basic polygon model, the tools for adaptation are the same, and no irreversible transformations take place within the framework of the modeling process.

Thanks to the assignment of predefined tools for adaptation to each basic polygon model, the same system can be used to set up and perform adaptation processes for different object types without much effort. In the next lower level, many different adaptable objects of an object type can efficiently be generated from the base model. Overall, a high degree of scalability results from this.

The adapting of the polygon model can be carried out in a fully automated manner, on the basis of input data. The tools for adaptation are thus applied to the polygon model in a fully automated manner, on the basis of the current polygon model (incl. local and global attributes) and the input data mentioned above, so that an adapted polygon model results from this. In this way, the individual adaptation of the geometry of an object can take place at any time, independent of the availability of skilled personnel. If the combination of adaptation of the polygon model and preparation of image data can be performed within a few seconds or faster, i.e. in real time, so to speak, a virtual fitting is possible during the adaptation process until the perfectly fitting geometry is defined, for example on the basis of feedback from the future user or wearer. Method steps which require an aesthetic evaluation by a user are thus preferably semi-automated, in that the user provides inputs and makes decisions, but these are supported and partially automated as much as possible by the computing device.

It is preferred that the input data comprise processing data which are obtained from geometry information about a counterpart of the object. This enables an adaptation of the geometry of the object to be achieved in a fully or partially automated manner with respect to an aesthetic appearance of the combination of the object and the counterpart and/or with regard to a good fit of the object, i.e. with regard to the best possible ergonomics.

In particular, the geometry information is obtained from a three-dimensional image of a region of a person's body. For example, in this way, an image of the person's head is used for the adaptation of a spectacles frame, an image of the person's ear region is used for the adaptation of the housing of a hearing aid, and images of the person's feet are used for the adaptation of shoes.

The term “a three-dimensional image of the body region” is intended to be understood to mean a dimensionally accurate image of the corresponding surface including depth information. The acquisition of the three-dimensional image can be done directly, by using an imaging technology that can directly detect the three-dimensional shape. The acquisition may also be carried out indirectly, for example by suitably computer-processing a plurality of two-dimensional images from different perspectives with reference to one another. The acquisition may also consist in receiving raw data for generating the three-dimensional image, or data already obtained or processed in three dimensions, from an external source via a suitable interface.

Suitable technologies for obtaining three-dimensional images are known in principle. For direct acquisition, there are time-of-flight-based systems (TOF cameras), stereoscopic systems or triangulation systems or interferometric systems. Light field cameras can also be used. The indirect calculation can be based on raw data of common (digital) cameras.

Within the framework of the method in accordance with the invention, a plurality of images of the same region can be acquired and processed, for example a plurality of frames of a video recording. This increases the precision that can be achieved. In the case of a capture of a facial region, for example, it is also possible for images to be captured which show different facial expressions—to ensure that the customized object (for example, a pair of spectacles) fits and looks aesthetically pleasing in different situations. In the case of a capture of a foot, the foot may be captured in different positions of the foot (standing flat, on tiptoes, etc.) in order to obtain additional information regarding the physiology with regard to the adaptation of a shoe.

It is preferred that, during the course of the generation of the first processing data, a plurality of orientation points are identified on the body region of the person, and their position is stored. The identification of the orientation points is carried out on the basis of the image, and, once they have been identified, they are transferred to the three-dimensional polygon model, are marked and stored. The body region of the person is thus measured, and features which are relevant for the adaptation of the object are made available for the further, automated processing of the data. In particular, they are used for an automatic positioning and orienting of the three-dimensional image and the subsequent automated adaptation of the polygon model.

For certain body regions, for example the face, program libraries and/or SDKs (software development kits) are available in order to directly generate models (for example head models) with orientation points from camera data, for example from mobile terminal devices.

It is preferred that the processing data are obtained from the geometry information by a process which is based on machine learning.

Such processes (machine learning, ML) are known and make an automatic processing (for example classification) of complex input data possible. By continuously training the process with new training data, the quality of the processing is continuously increased. In the present case, the application of the ML process makes a continuous reduction of the required iterations possible until the polygon model represents the object geometry desired by the user. The ML process can be used, on the one hand, for recommending an initial design that fits the physiognomy of the future wearer, and, on the other hand, for the automatic adaptation of the shape and positioning of the polygon model to the physiognomy during the subsequent modeling process, for example on the basis of the identified orientation points.

Suitable ML algorithms are based, for example, on support vector machines (SVM) or artificial neural networks.

In the present case, in particular ML processes are likely to be used which are based on supervised learning.

Advantageously, the ML process is based on a multitude of training data from three-dimensional images of a multitude of persons and adapted polygon models associated therewith.

Thus, in the present case, the data that are required for the application of the corresponding ML process are obtained from first data (for example, the orientation points) obtained from the three-dimensional images (and possibly second data, if available and useful) and the polygon models ultimately generated, i.e., the model parameter values that represent these adapted models. Other sources of data are possible—for example, photographs that are available and that show the counterpart of the object together with the object (for example the face of persons with spectacles on) and where the object geometry is judged by persons or by a suitable algorithm to be fitting for the counterpart, can be used as training data. It is also possible to use “negative” training data which represent a poor fit of an object.

It is preferred that the initial training data are based on a manual or semi-automatic adaptation of objects of the respective object type, for example within the framework of a computer-assisted adaptation process with a virtual fitting, but where the adaptation of the model has been carried out manually by an operator. In this context, for the training of the ML algorithm, only the parameters of accepted models are used. If there is a sufficient number of associations between 3D images and accepted polygon models (for example at least 100, preferably at least 500), a noticeable improvement of the adaptation process can already take place with the aid of the trained ML algorithm.

It may then even be possible to carry out the adaptation without any content-related feedback from the user in the context of a virtual fitting, i.e. without the output of image data of a superposition of the adapted and refined polygon model with a view of the counterpart, because there is a sufficiently high degree of certainty that the object that has been adapted in a fully automated manner will fit perfectly.

Advantageously, the machine learning process is further based on data relating to properties of the person, in particular an age, a gender, an ethnic origin and/or information relating to preferences of the person. Based on these, the person can be assigned to a target group. From the training data, it is known which preferences the corresponding target group has with respect to the customized object and, if applicable, the adaptation. Accordingly, the selection of the base model and/or the automated adaptation of the polygon model can be adapted in accordance with these preferences.

In particular, the association with the adaptation group may be indicative of an association with a spatial region of the polygon model, i.e., a three-dimensional region. Tools for adaptation may in particular make a deformation of mesh elements dependent on whether they are associated with this spatial region. For example, a tool for adaptation may selectively affect only those mesh elements that belong to a particular aesthetic and/or functional subsidiary unit of the object.

In accordance with this, the set of predefined tools for adaptation advantageously comprises at least one local tool for adaptation the application of which to the polygon model has an influence only on a local region of the model, whilst leaving all regions outside this local region unaffected. In this way, it can be ensured that the influence of several tools for adaptation on the polygon model is substantially independent of each other, which simplifies the planning of the sequence of the adaptations that are necessary. In particular, a local tool for adaptation relates only to one specific element of the object, in the case of a spectacles frame, for example, only the bridge or the attachment region for a temple.

The locality of the tools for adaptation may be achieved by assigning, to the elements of the polygon mesh, the association with one or more groups. For example, the groups may be assigned as a binary bit field (0: not part of the group; 1: part of the group) to each element of the polygon mesh. Then, when the local tools for adaptation are being applied, only those elements will experience its effect which are identified as part of the corresponding group. The groups thus serve as masks in order to restrict the deformations to certain regions of the polygon mesh during the adaptation process.

The association with the adaptation group may in particular be indicative of an association with a guide curve of the polygon model, i.e. with a two-dimensional (continuous) line. Such guide curves impose conditions on the adaptation steps which are carried out with the corresponding tools for adaptation within the framework of the adaptation process, in this way, for example, the curvature or the position of an inflection point of the guide curve should (as far as possible) be preserved within the framework of such an adaptation. Preferably, the tools for adaptation are predefined and applied in such a way that predetermined guide curves of the model are preserved as best as possible. Thus, within the framework of any local deformation, the transition to the neighboring regions of the modeled object is always automatically adapted as well.

In addition, the guide curves can be employed within the framework of guidance by a user: For example, a user can influence the geometry which is represented by the polygon model by specifically influencing parameters such as curvatures or positions of inflection points or further points of reference along a guide curve. It may also be possible to represent two-dimensional projections on planes in which guide curves run. Accordingly, changes can be made to the geometry within the framework of the representation of such projections. In an analogous manner, guide curves can also be employed in the automatic adaptation of the polygon model.

In addition, guide curves may be employed when a refinement of the polygon model is to be carried out, in that this is carried out in a fully automated manner in such a way that the refined polygon model follows the guide curve of the initial polygon model. Such a fine adjustment is made in particular after an adaptation of the geometry of the object has been carried out within the framework of the adaptation process. It is based in particular on the knowledge of the properties of the algorithms used for the subdivision steps. Remaining degrees of freedom, in particular with respect to the positioning of the nodes of the polygon mesh, can be used in order to select positions already within the polygon model that lead to an advantageous local geometry of the polygon mesh during the subsequent subdivision.

The association with the adaptation group may in particular also be indicative of a point of reference of the polygon model. Fixed positions may, for example, be assigned to such points of reference, or such points of reference correspond to known positions of the counterpart to which the geometry of the object is to be adapted. Thus, such points of reference also impose conditions on the adaptation steps which are carried out with the corresponding tools for adaptation within the framework of the adaptation process, for example, the position of a point of reference should remain unchanged.

The parameter for the deformation process may in particular specify a radius for a rounding of an edge or a deformation weight. The respective values are taken into account by the tools for adaptation when the deformations to be performed are being defined, so that, for example, a curvature measured perpendicular to an edge comes to lie within a certain predetermined region after the deformation, or that the deformation is different at different points of the same object region.

On the basis of the deformation weight and/or other local attributes of mesh elements affected, at least one of the tools for adaptation may thus determine an extent of a deformation. Depending on the type of deformation and the content of the respective attribute, the extent may be determined in an absolute manner or relative to other quantities, or lower and/or upper limits for the deformation may be derived. For each mesh element, several local and/or global attributes can be used in order to define the extent of the deformation. Where appropriate, local attributes which are assigned to other mesh elements (for example in the vicinity of the mesh element directly affected) are also used. However, it is preferred to define the local attributes and the tools for adaptation in such a way that, in addition to the global attributes, only the local attributes which are assigned to the mesh element affected need to be taken into account.

In particular, the at least one tool for adaptation restricts a maximum deformation for mesh elements which belong to a guide curve of the polygon model or which form a point of reference of the polygon model. The restriction results in the allowable deformation being in particular smaller than for other mesh elements in the vicinity. The restriction may be specified as relative (in comparison to other deformations) or absolute. It may also make certain adaptations of certain mesh elements impossible altogether, as has been mentioned above in connection with points of reference.

In an advantageous manner, the local attributes that are assigned to a mesh element of the polygon model may be indicative of the association with a plurality of adaptation groups, in particular the association with a plurality of spatial regions of the polygon model. In particular, the local attributes may be indicative of the association with a plurality of adaptation groups of the same class (for example, guide curve or spatial region). In this way, it becomes possible, for example, for regions to overlap and for guide curves to intersect, which increases the flexibility in terms of what can be specified for the geometry and allows associations to be defined for different tools for adaptation. The definition and combination of overlapping adaptation groups gives rise to relationships of the individual partial regions of an object. These are used in the data-driven automated adaptation of all regions of the object in that, during the deformation, the tools for adaptation automatically take into account, for the purpose of the deformation calculations, the interaction of regions of the polygon mesh which influence one another.

In an advantageous manner, for a mesh element which is associated with a plurality of adaptation groups, a tool for adaptation determines a first partial deformation on the basis of an association with a first one of the adaptation groups and a second partial deformation on the basis of an association with a second one of the adaptation groups, and a deformation applied to the mesh element is derived from the first partial deformation and the second partial deformation. In this way, it becomes possible for a tool for adaptation which has an effect on a plurality of adaptation groups to carry out the desired deformation also in regions of overlap. The derivation can be carried out in a variety of ways, for example the deformations can be carried out one after the other in the sense of a convolution (if applicable in a specified order) or the deformation represents an average of the two partial deformations.

Preferably, the adaptation steps are carried out with the tools for adaptation from the set of predefined tools for adaptation in accordance with predetermined rules and with predetermined priorities.

The predetermined priorities result from a fixed, predetermined order and/or are determined as a function of input parameters by a predetermined decision scheme.

The method in accordance with the invention for generating geometric data of a personalized object can be used in particular in a method of generating manufacturing data for a personalized object for a person, comprising the following steps:

a) capturing at least one three-dimensional image of a body region of a person;

b) generating input data from the three-dimensional image;

c) providing the polygon model and the set of predefined tools for adaptation in accordance with the method according to the invention;

d) adapting the polygon model on the basis of the input data;

e) outputting image data of a superposition of the adapted polygon model with a view of the body region of the person; and

f) outputting the manufacturing data generated from the adapted polygon model.

In a corresponding manner and in another embodiment, a system for generating manufacturing data for the manufacture of a personalized object for a person, preferably includes:

a) a camera for capturing one or more images of a body region of the person;

b) a first processing module for generating a three-dimensional image of the body region from the one or more images;

c) a second processing module for generating input data from the three-dimensional image;

d) a modeling module for providing a polygon model for the object to be produced;

e) an adaptation module for automatically generating adaptation data for the modeling module on the basis of the input data;

f) an image output module for outputting image data of a superposition of the model with the one or more images of the body region of the person;

g) an output device for receiving and displaying the image data that have been output;

h) a third processing module for generating manufacturing data from the polygon model;

i) a data output module for outputting the manufacturing data.

The camera may be a still camera or a video camera, whereby the term “camera” includes any conceivable image capture devices. In particular, the camera is part of a mobile terminal device (for example smartphones or tablets). Preferably, it has the ability to directly capture three-dimensional images, for example supported by integrated infrared sensors for depth measurement. This can eliminate the need for dedicated additional capture devices; the customer or a service provider can use a terminal device which is already in existence or which is readily available and can be bought at relatively low cost.

To generate the image data, the edges of the object may be rounded after the adaptation has taken place. The rounding takes place as a function of the angle of the adjacent faces of the edges to be rounded. Subsequently, the polygon model is suitably positioned with respect to the image or images of the body region.

The outputting of the image data may directly include the displaying on an output device, but, as a rule, the image data (in a form which is suitable for immediate output, or as precursor data that can be further processed into image data) are transmitted to, and displayed on, a terminal device which is positioned at a remote location. This transmission takes place in particular via a computer network (WAN or LAN). The images may ultimately be output in a static manner or in a moving manner (video overlay).

Preferably, the steps d) and e) of the method and the manual input of data are carried out in a cyclic manner until the user accepts the current model and approves it for manufacturing. Subsequently, the manufacturing data are generated.

The cyclic process may include further steps. For example, a sample copy of the object may be produced and tried on. Depending on the result of the fitting, this may in turn result in second data which are used in the further adaptation.

With the aid of the method in accordance with the invention, the adaptation process can in particular be carried out in a fully automated manner, as a consequence of which the configuration and the ordering of a personalized object can take place at any time, irrespective of the availability of skilled personnel. As the combination of parameter adaptation and preparation of the image data can be carried out within a few seconds or less, that is to say in real time, so to speak, the virtual fitting during the ordering process and the carrying out of several iterations, on the basis of the feedback from the future wearer or user, until the definition of the perfectly fitting object, are possible without undue problems.

On the customer side, the method in accordance with the invention can be fully supported by state-of-the-art devices such as smartphones or tablets, whereby a specific app or a web-based application in the browser can be used.

Preferably, the method in accordance with the invention is controlled and the system in accordance with the invention is constructed in such a way that the following steps can be carried out in a fully automated manner and that there is no need for any manual actions on the part of the service provider:
the capturing of the body region;
the generating of the 3D model of the body region;
the orienting and positioning of the 3D model of the body region;
the finding of a parameter configuration for the personalized object;
the generating of the 3D model of the object;
the generating of the preview of the 3D model of the object together with the three-dimensional body region;
the generating of all production data;
the transmitting or providing of the production data to the manufacturers.

A system for manufacturing a personalized object for a person preferably includes the system, described above, for generating manufacturing data and a first device for additively manufacturing the at least one element of the object to be manufactured on the basis of the output manufacturing data.

The polygon model is preferably provided with a first density of a polygon mesh and adapted. For outputting the image data, the polygon model is then transformed by at least a first subdivision step into a first refined polygon model having a second density of the polygon mesh, wherein the second density is higher than the first density, and for outputting the manufacturing data, the polygon model is then transformed by at least a second subdivision step into a second refined polygon model having a third density of the polygon mesh, wherein the third density is equal to, or higher than, the second density.

The image data for output are thus generated from the original polygon model, the partially adapted polygon model or the fully adapted polygon model, preferably in real time, i.e. in such a way that adaptations made are tracked within the framework of the display of the personalized object together with the view of the body region of the person, without the user having to issue any additional request in this respect and without any noticeable delay.

In a corresponding manner, the system preferably includes a transformation module for transforming the polygon model into a first refined polygon model having a second density of the polygon mesh, wherein the second density is higher than the first density, and for transforming the polygon model into a second refined polygon model having a third density of the polygon mesh, wherein the third density is equal to, or higher than, the second density.

The polygon model is initially provided at the first density. The image output module is then operated on the basis of the first refined polygon model, and the third processing module uses the second refined polygon model as a point of departure.

The adaptation process as well as the virtual fitting and the fabrication are ultimately based on the same polygon model. The parameterizations for the fitting and for the fabrication are obtained from this underlying model through the subdivision steps. In this way, the processing is simplified, and, through the coherence between the data for the fitting, the preview and the production, errors arising in the course of the transition between different models, which may be due to different parameterization types, are avoided.

In a preferred embodiment, the manufacturing data encode additive manufacturing using multiple different materials. The materials may differ from each other in terms of material parameters, colors and/or additives. The different materials may preferably be used in the same additive manufacturing process. The production of homogeneous objects “from a single mold” that have heterogeneous material properties is made possible through this. By this, it becomes possible, for example, to realize hinge solutions not only on a geometric basis, but also through the distribution of material in the object. The possibilities of multi-material printing can be taken into account in the course of the parameterization of the object during the adaptation process.

Preferably, on the basis of the data of the polygon model, an assignment step is automatically carried out in order to assign different materials to different regions of the object to be manufactured. This makes a fully automatic and efficient generation of the manufacturing data possible. The same applies to different manufacturing processes: Thus, for example in the case of the personalization of a spectacles frame, the rims are advantageously adapted together with the temples and hinges (and, if applicable, with other elements), and, on the basis of the model finally selected, the manufacturing data are automatically generated together with the assignment to different manufacturing processes and materials.

Details regarding different materialization and/or on different manufacturing processes may be obtained by the assignment step alone, or they may already be encoded in whole or in part in the local attributes of the polygon model.

Advantageously, the method includes the further step of a manual input of further input data, whereby these further input data are used in the course of the adaptation of the polygon model. Such manual inputs may, for example, be provided directly by the future wearer or user of the personalized object, or by a consulting service provider or a professional (for example, an optician, a hearing aid mechanic, a shoemaker, etc.) who is present with that person or who communicates live with that person (for example, via a video chat). The manually entered further input data relate, for example, to preferences (fashion style, color, material, price range) in relation to the object to be manufactured or to additional information which is required for generating the manufacturing data.

Likewise, these additional input data can be based on a process whereby certain measurements of the body region are first determined by special instruments. From this, core parameters can then be obtained. This type of acquisition represents an alternative to the extraction from the processing data. However, the measurements can also be used precisely for the purpose of calibrating the acquired 3D image and/or the processing data generated therefrom, as a result of which the manufacturing precision can be increased significantly. The simultaneously capturing of an image of the body region together with a reference object (for example, a tape measure) represents an alternative. Certain devices and methods are also capable of performing absolute distance or position measurements without such additional measures.

Preferably, the further input data can be input after the image data have been output, after which the steps d) and e) are carried out again in dependence upon the further input data. The future wearer or the consulting service provider (or some other person) can thus provide feedback on the current design of the personalized object on the basis of the current polygon model. This may consist of a simple YES/NO answer, or in multiple YES/NO answers to different questions, but it may also include specific influencing parameters—for example, the inputting person may select and manipulate elements of the object with the aid of a graphical user interface. The graphical user interface may, for example, provide for the user to “pull” at elements of the object in order to directly influence their dimensions and/or their shape. In addition or as an alternative, for example sliders may be provided, with which the user can influence certain aspects (dimensions, rounding, colors, etc.). From each of these, input data are generated which correspond to an adaptation of a parameter of the polygon model.

In particular, second data are manually acquired before the first displaying as well as afterwards. The first acquisition concerns general preferences and general conditions, the further acquisitions concern feedback on the current state of the adaptation. After the adaptation has been completed with the user, a further person (for example, on the part of the consulting service provider or the manufacturer) may make final adaptations before the object is manufactured.

When the method is used to generate geometric data for a personalized spectacles frame, the set of predefined tools for adaptation preferably includes a plurality of the tools for adaptation described below by way of example:

a. A tool for adaptation for the purpose of modifying at least one dimension of a nose bridge of the pair of spectacles to be manufactured. Such a tool for adaptation may have an influence on one or more of the following properties:
Bridge width: In this context, the width of the nose bridge is increased or decreased. In the course of this, the frame thickness does not change. The total width of the frame front decreases by the amount of the change in the nose bridge, so that the total width of the front of the spectacles frame remains unchanged.
Depth of the nose bridge: In this context, the depth of the nose bridge is increased or decreased. The remaining thickness of the frame is not changed.
Width of the nose bridge in the lower part: This can be increased or decreased separately. As a result, the angle of the nose pads changes. The overall width of the nose bridge remains unchanged and the width of the front of the frame does not change as a result.

b. A tool for adaptation for the purpose of changing at least one overall dimension of the front of the pair of spectacles (for example the width of the front and/or the height of the front) while maintaining an overall shape of the front of the pair of spectacles. The shape of the lens opening, and thus the shape of the lens, adjust accordingly. The width of the nose bridge does not change and the design of the pair of spectacles remains the same. In addition, the thickness of the frame can optionally be changed in depth.

c. A tool for adaptation for the purpose of affecting a base curve. The base curve concerns the curvature of the lens glass and thus also the geometry of the frame. The base curve corresponds to a projection of the spectacles frame onto spheres having defined radii for the different base curves. The center of the sphere onto which the projection is made is positioned in the optical center of the lens glass. The base curve can be increased or decreased with the tool for adaptation. The thickness of the spectacles frame remains the same. Similarly, the width of the spectacles frame remains the same since the projection is realized by shearing the shape in depth onto the sphere.

d. A tool for adaptation for the purpose of changing a geometry of a lens groove for receiving a lens glass. The lens groove fixes the lens glass in the spectacles frame. The geometry thereof can be selected to be round as well as pointed. Further, the depth of the groove can be changed.

e. A tool for adaptation for the purpose of changing an angle between a front of a pair of spectacles and an end piece of a center portion of the pair of spectacles. Since the temple is connected to the end piece by a hinge, this results in a change of the angle of the temple relative to the front of the pair of spectacles. Thus, on the one hand, the angle of the temple with respect to the front of the pair of spectacles can be changed. In this context, only the end piece of the spectacles frame is modified. The front of the pair of spectacles does not change. Further, the inclination can be increased and decreased. For this purpose, the front of the pair of spectacles is pivoted about a point on the end piece. The temples of the pair of spectacles do not change as a result of this.

f. A tool for adaptation for the purpose of changing a dimension and/or a position of the nose pads (in relation to the other elements of the frame). The nose pads can be modified as regards their overall shape, their height, their depth, and their angle. All other dimensions of the spectacles frame are not affected by this. The nose pads can also be modified in such a way that there are no pads any more on the frame. In this case, holes are provided in the lower region of the nose bridge to allow metal webs with silicone nose pads to be attached after production.

g. A tool for adaptation for the purpose of adapting a dimension and/or a shape of a temple. With the aid of such a tool for adaptation, the length of the temple can be increased or decreased. The rim is not affected by this. In particular, by changing the shape, the bend of the temple around the ear and the bend of the temple around the head can be adapted. The temple can be bent at the temple tip. For this purpose, the position of the bend of the temple, the angle of the bend of the temple and the radius of the bend of the temple can be influenced with the aid of a further tool for adaptation. The rim is not affected by this.

Within the framework of the adaptation, all or some of the tools for adaptation mentioned above may be available or may be used. Further tools for adaptation are also possible. For example, with the aid of a further tool for adaptation, the curvature of the spectacles frame may be increased in the lower frame region from the nose bridge to the end piece of the pair of spectacles. This is necessary for the stability of certain models of spectacles.

The order of the tools for adaptation can be specified, for example, as follows: Width of the bridge-depth of the bridge-frame size-width of the bridge in the lower portion-modification of the upper, inner portion of the lens opening-radius of shaped lens-base curve-lens groove-angle of the temple-inclination-curvature of spectacles frame-nose pads-length of the temple-bend of the temple. In this way, it is ensured that the effects of any respective subsequent adaptation step in the corresponding iteration do not require any (re)adjustments with a tool for adaptation which has already been used previously in that iteration, regardless of the adaptations made.

Preferably, the method in accordance with the invention includes the additional step of defining openings for attaching further elements in the polygon model. In a spectacles frame, these openings serve, for example, to attach a hinge or the attachment elements of a metal/silicone nose pad. Advantageously, the further elements are simulated together with the object so that a correct alignment and positioning of the further elements in the assembled object results from the adaptation process and the definition of the openings.

Further advantageous embodiments and combinations of features of the invention will be apparent from the following detailed description.

### BRIEF DESCRIPTION OF THE DRAWINGS

Further advantages, features and possible applications of the present invention will be apparent from the following detailed description in connection with the drawings. The accompanying drawings, which are incorporated in and constitute a part of this specification, illustrate one or more embodiments of the invention and, together with the general description given above and the detailed description given below, explain the one or more embodiments of the invention.

FIG. 1 shows a schematic representation of the method phases of a method in accordance with the invention for generating geometric data and for further processing into manufacturing data and of the corresponding data model.

FIG. 2 shows a schematic representation of an overall system in accordance with the invention for generating geometry data and manufacturing data as well as for manufacturing a personalized object.

FIG. 3 shows a schematic representation of a system in accordance with the invention for manufacturing a pair of made to measure spectacles.

FIG. 4 shows a flowchart for the schematic representation of the order of sequence of a method in accordance with the invention for manufacturing a pair of made to measure spectacles.

FIG. 5A-F show schematic representations of the orientation points and the definition of the global coordinate system used.

FIG. 6A-C show representations of points of reference, a guide curve and a group on the polygon mesh.

FIG. 7 shows a representation of numerical values that are used for the control of the inclination (pantoscopic angle).

FIG. 8 shows a schematic representation of two basic topologies for the basic spectacles models.

FIG. 9A-D show various views of the head of the customer with a virtually superimposed spectacles frame.

FIG. 10 shows a flowchart of the parameter adaptation process.

FIGS. 11-20 show representations of the frame for the purpose of explaining the parameter adaptation functions.

FIGS. 21A-C show representations of a portion of the temple of the pair of spectacles in the original polygon mesh, in a refined polygon mesh for display, and a refined and further processed polygon mesh for additive manufacturing.

In principle, the same components are provided with the same reference signs in the figures.

### DETAILED DESCRIPTION

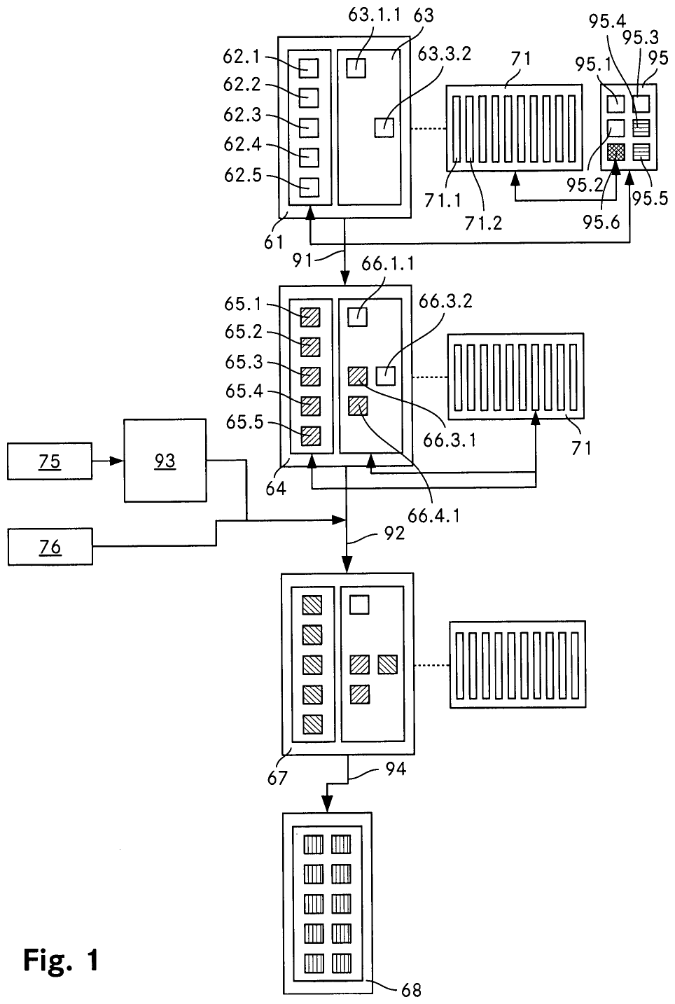

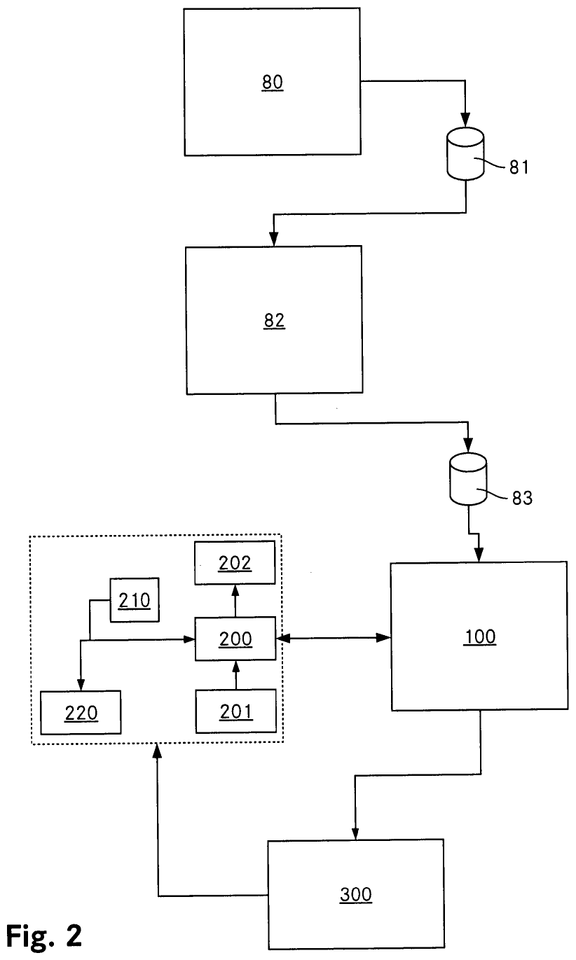

FIG. 1 is a schematic representation of the method phases of a method in accordance with the invention for generating geometric data and for further processing into manufacturing data and of the corresponding data model. FIG. 2 is a schematic representation of an overall system in accordance with the invention for generating geometric data and manufacturing data as well as for manufacturing a personalized object.

First, a basic polygon model 61 that corresponds to the object type of the personalized object to be manufactured and a set of tools for adaptation 71 associated to the basic polygon model 61 are provided. The basic polygon model 61 includes, by way of example, mesh elements 62.1, 62.2, . . . , 62.5 as well as associated local attributes 63.1.1, 63.3.2. The set of tools for adaptation 71 includes a plurality of tools for adaptation 71.1, 71.2, etc. The tools for adaptation 71.1, 71.2 are adapted to the basic polygon model 61 in such a way that the data of the mesh elements 62.1 . . . 5 can be processed in dependence upon the local attributes 63 and other input data.

Further, tools 95 for modeling the basic polygon model 61 are provided. These tools comprise standard tools 95.1, 95.2, 95.3, for example for smoothing, distributing or aligning, or for generic shape changes, as well as tools 95.4, 95.5 that are specifically geared towards the basic polygon model 61 of the object type. Further, there is an interface to the tools for adaptation 71.1, 71.2 of the set of tools for adaptation 71 such that these tools (or some of them) and/or derivatives that use these tools can also be applied to the basic polygon model 61 by the designer within the framework of the modeling process.

The provision of one or more basic polygon models, the associated sets of tools for adaptation, the tools 95 as well as the storing in a database 81 is carried out by a first service provider 80.

A designer 82 creates, on the basis of the basic polygon model 61, an initial polygon model 64 (modeling process 91) from the database 81 by modifying the mesh elements 65.1 . . . 5, in particular the position of the individual mesh nodes, by common tools in order to obtain a desired shape of the object represented. Likewise, he may add or adapt local attributes 66.3.1, 66.4.1, for example in order to specify a desired rounding of edges or in order to change the association of certain portions of the polygon mesh to adaptation regions. Further local attributes 66.1.1, 66.3.2 are identical to those of the basic polygon model 61. The associated set of tools for adaptation 71 remains unchanged.

The initial polygon model 64 is stored in a database 83. This database 83 typically comprises a whole range of polygon models that represent different design variants (models) of an object of a particular type. All of these design variants have the same tools for adaptation in common, whereby certain tools for adaptation are, at most, ineffective for a particular variant by the setting of local and/or global attributes accordingly, for example because they are intended for the processing of an optional element which is absent from the variant in question or because the corresponding degree of freedom has deliberately not been enabled by the designer 82 to be used, for example because the basic character of the design variant would be lost as a result of corresponding adaptations.

In a next step, the polygon model 64 is then adapted in an adaptation process 92. This is described in more detail below in connection with a system and a method for manufacturing a pair of made to measure spectacles. In principle, within the framework of this adaptation process 92, a polygon model 64 with the desired appearance and/or functionality is first selected and loaded from the database 83. After this, the tools for adaptation 71 are used in order to adapt the mesh elements 65.1 . . . 5 of the selected polygon model 64, in particular in order to change the positions of the mesh nodes. Local attributes 66.3.2 can also be changed selectively, for example, an edge rounding can be influenced in order to make edges rounder or more angular. The adaptation of the polygon model 64 is based, on the one hand, on input data that are obtained from a three-dimensional image 75 of a counterpart (for example, a body region of a future wearer or user) by a machine learning process 93, and, on the other hand, on input data 76 that additionally feed into the adaptation process, for example manually entered feedback from the wearer or user or another operator. As is described in more detail below, the user receives a virtual preview of the object in accordance with the current adaptation. Advantageously, this also shows the counterpart (for example a body region) to which the object is to be adapted.

For the purpose of the adaptation, a server 100 of a service provider communicates with a computer 200 which is located at a distance from the server 100, for example at the prospective wearer's or user's premises or at the business premises of a provider (for example premises of an optician, a hearing aid shop or a shoe shop). The computer 200 is equipped with a keyboard 201 (and other input devices) as well as a screen 202. It is also connected to a camera 210 with 3D functionality and a local 3D printer 220 for producing sample prints. The computer 200 and thus the peripheral devices that are connected to it communicate with the server 100 via a suitable interface of the computer 200, a data network (for example the Internet, via a connection secured with TLS, for example) and an interface of the server 100. The computer 200 with keyboard 201 (and/or other input device) and screen 202 on the one hand and the camera 210 with 3D functionality may be integrated into the same terminal device, in particular a tablet computer or a smartphone.

This results in an adapted polygon model 67. Manufacturing data 68 may then be obtained from this by a processing step 94. The manufacturing data 68 primarily represent the shape of the object in accordance with the mesh elements of the polygon model 67. However, as is described further below, the resolution may be more refined when compared with the polygon model used for the adaptation process 92, i.e. more mesh elements are present. The manufacturing data 68 are then transmitted to one or more manufacturers 300. These ultimately deliver, directly or indirectly, the manufactured product to the wearer or user of the personalized object.

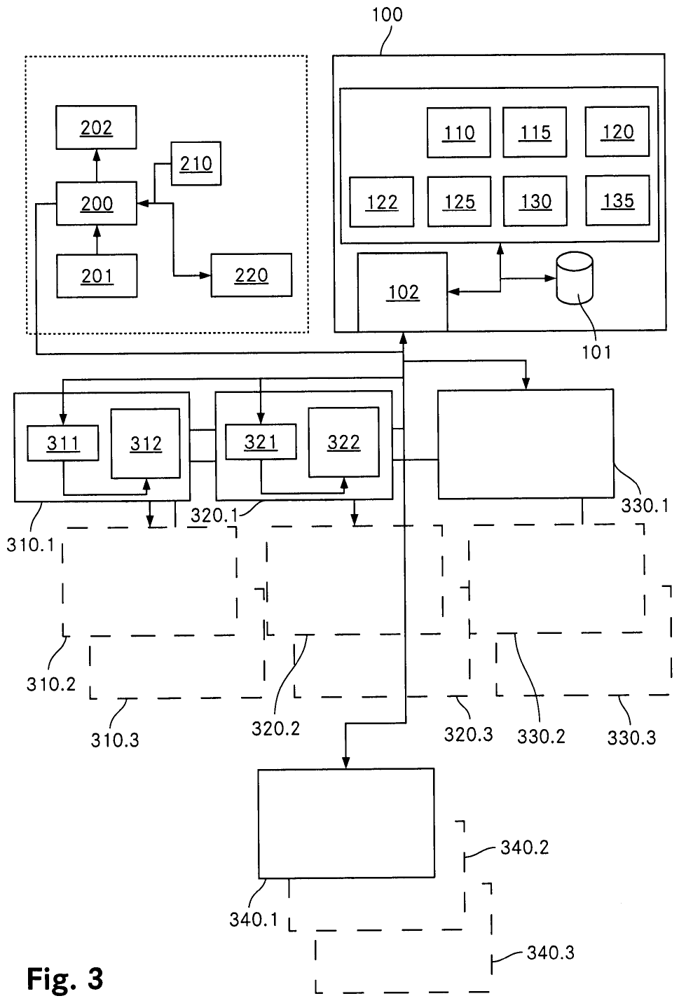

FIG. 3 is a schematic representation of a system in accordance with the invention for manufacturing a pair of made to measure spectacles. In the interest of an improved overview, only the data connections between the individual elements are shown, whereas the physical transports are only apparent from the text of the description.

The system comprises a server 100 of a service provider that comprises standard computer hardware. In terms of functionality, it comprises a database 101, an interface module 102 and at least the following functional modules:

a) a processing module 110 for generating input data from a received three-dimensional image of a head of a person;

b) a modeling module 115 for providing a model for a spectacles frame;

c) an adaptation module 120 for generating adaptation data and for effecting adaptations to said model;

d) a transformation module 122 for transforming a polygon mesh into a refined polygon mesh;

e) an image output module 125 for outputting image data of a superposition of the model with one or more images of the head of the person;

f) a processing module 130 for generating manufacturing data from the model; and

g) a data output module 135 for outputting the manufacturing data.

The modules communicate with the database 101 and the interface module 102. Their operation and interaction is described in more detail further below, in connection with a method in accordance with the invention.

The system comprises the computer 200 described above, which communicates with the server 100 via the interface of the computer 200, a data network and the interface module 102 of the server 100. The computer 200 with keyboard 201 (and/or other input device) and screen 202 on the one hand and the camera 210 with 3D functionality may be integrated into the same terminal device, in particular a tablet computer or a smartphone.

Also connected to the server 100 via the interface module 102 are a plurality of manufacturers 310.1, 310.2, 310.3 of a first group that have facilities for additive manufacturing, a plurality of manufacturers 320.1, 320.2, 320.3 of a second group that have facilities for manufacturing spectacles lenses, a plurality of manufacturers 330.1, 330.2, 330.3 that are capable of carrying out further manufacturing operations, and a plurality of service providers 340.1, 340.2, 340.3 with facilities for assembling a plurality of components of a pair of spectacles.

The facilities of each of the various manufacturers comprise—as illustrated in the case of the first manufacturer 310.1 of the first group and the first manufacturer 320.1 of the second group—respective computers 311, 321 having suitable interfaces for communicating with the interface module 102 of the server 100 (again preferably via a secure Internet connection) and corresponding manufacturing facilities, for example a machine 312 for additive manufacturing or an automatic grinding machine 322 for processing lens blanks.

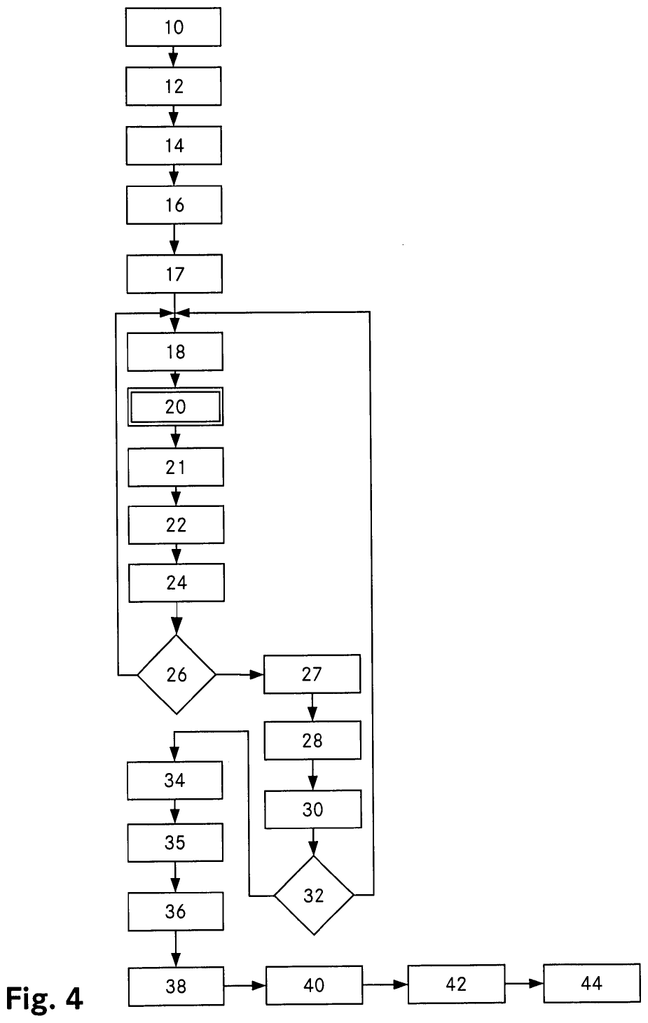

FIG. 4 schematically illustrates the flow of a method in accordance with the invention as a flow chart. A customer who wants a new pair of spectacles goes to the business premises of the optician whose company is integrated into the system in accordance with the invention and/or interacts with the system in accordance with the invention. The optician determines—as is customary—the optical characteristics which the pair of spectacles is supposed to have, in particular with respect to the spherical and cylindrical correction values, the axial position of the cylinder, prismatic values and base positions as well as the vertex distance. In the case of multifocal or free-form lenses, further data needs to be collected.

First, general parameters relating to the desired pair of spectacles are collected via the computer 200 and the keyboard 201, supported by the screen 202, and forwarded to the server 100 of the service provider (step 10). The general parameters comprise, in addition to the information relating to the optical properties, a (first) selection from various base models. These are physically available at the optician's so that the customer can pick them up with their hand and put them on for testing. For many customers, this simplifies the virtual fitting later on, because the relationship between the pair of spectacles, put on and displayed on a screen, and the represented physical object can be made much more accessible. The general parameters further include, among other things, the specification of the material or materials, the desired color, an inscription on the temple(s), etc. Already at this stage is it also possible to enter certain preferences in respect of the geometry of the rim, for example a (relative) lens size or a base curve. The scope and allowable ranges of the parameters may vary depending on the base model.

Next, a three-dimensional image of the client's head is captured with the aid of the camera 210 (step 12). The image comprises at least the entire face, the forehead with hairline, the temple regions, and the ears. The three-dimensional image data are in turn transmitted to the server 100. The acquisition may be carried out with the aid of commercially available products, for example with modern tablet computers or smartphones that are equipped with cameras which are capable of capturing depth information (typically in an infrared-supported manner). As a rule, it makes sense to take several images from different angles and then to assemble them into a 3D model. Corresponding applications and library functions are available. They can be run directly on the terminal device used.

Initial input data are then generated from the three-dimensional image data in the processing module 110 on the server by predetermined orientation points being identified on the basis of image recognition and their position on the client's head being stored in the database 101 (step 14). The result is a 3D polygon model with associated texture.

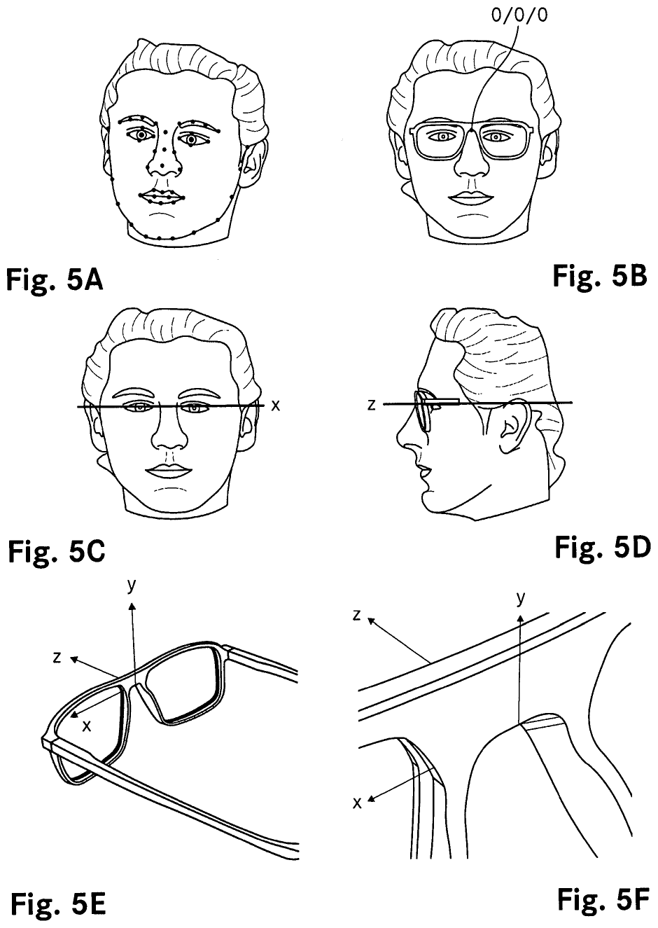

As is shown in FIG. 5A, in particular elements of the mouth, the nose, the eyes, the eyebrows, the ears and the facial contour serve as orientation points. The orientation points are first identified on the two-dimensional image and then projected onto the 3D polygon model. The three-dimensional location information results from this. With the help of the three-dimensional location information, the head can be oriented in space (pupils on one axis, root of the nose at a fixed position in space, etc. . . . ). The model of the pair of spectacles is subsequently always positioned in such a way that the base of the columella of the nose is positioned at the coordinate origin (0/0/0) of the global coordinate system (FIG. 5B). The front of the pair of spectacles is aligned so as to be parallel to the global X-axis (FIGS. 5C, 5E, 5F). The temples are aligned so as to be parallel to the global Z-axis (FIGS. 5D-F). Accordingly, the 3D head scan is first rotated in such a way that the orientation points of the pupils are aligned so as to be parallel to the X-axis (FIG. 5C). Then, the 3D scan is positioned such that the orientation point of the root of the nose is in the origin of the coordinate system (FIG. 5B). The 3D scan is then rotated about the orientation point of the root of the nose such that the orientation point of the ear is below the temple of the pair of spectacles (FIG. 5B).

Also—based on the general parameters that have previously been acquired—a polygon model for a spectacles frame having the desired basic properties is provided in the modeling module 115 (step 16). This polygon model comprises a polygon mesh, i.e. a mesh of discrete elements consisting of points, edges and polygon faces. Each individual element carries basic information such as position, orientation, and adjacent neighboring elements, as well as additional data fields such as association with a group or groups and attributes that define the parametric shape.

The association with a group or groups is automatically specified. This is in the form of binary bit fields (0: not part of the group; 1: part of the group).

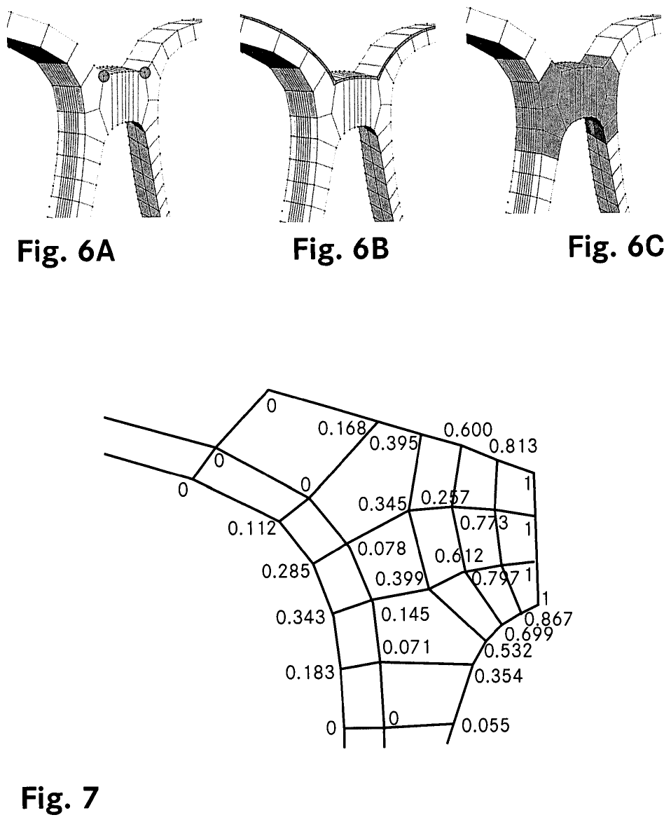

The groups can represent surface regions, lines, guide curves—as they are referred to—(for example the upper front curve or the upper back curve), or points, in particular points of reference (for example the nose bridge point or the front cheek corner) by binary bit fields. FIG. 6A shows, by way of example, two points of reference of the frame nose bridge, FIG. 6B shows the front upper guide curve of the frame, and FIG. 6C shows the “frame nose bridge” region.

The points of reference mark important locations on the model, such as for example inflection points of the guide curves.

The groups, that is to say regions, guide curves and points of reference, serve as masks in order to restrict the deformations to certain regions of the polygon mesh in the subsequent adaptation process. The definition and combination of overlapping groups of the various polygon mesh elements gives rise to relationships of the individual partial regions of an object. This automatically has the result that—in particular in the case of a data-driven, automated adaptation of the object geometry—during the deformation, the adaptation procedures automatically take into account, for the purpose of the deformation calculations, the interaction of regions of the polygon mesh which influence one another. In addition, the guide curves and points of reference may be linked to conditions that need to be met within the framework of the adaptation process. In this way, for example, a radius of curvature along a guide curve or at a point of reference should be within certain limits, or the position of an inflection point of a guide curve should be within a certain range.

In addition, further data are written onto the polygon mesh elements, which are used for the control of the subsequent deformations. FIG. 7 shows, by way of example, the numerical values that are used for the control of the inclination (pantoscopic angle). These are values from a substantially continuous spectrum (for example between 0 and 1), on the basis of which the influence through a deformation process (deformation weight) can be controlled in a quantitative manner. In a similar manner, such quantitative values may be indicative of the radius of edge rounding, for example.

In addition to the local data fields, the polygon model also includes global attributes, in particular semantic information in relation to the type of the object represented (for example, “front of a pair of spectacles”, “temple of a pair of spectacles”, etc.) and design variants (in the case of a front of a pair of spectacles, for example, “standard”, “double bridge”, “upper bridge”, etc.).

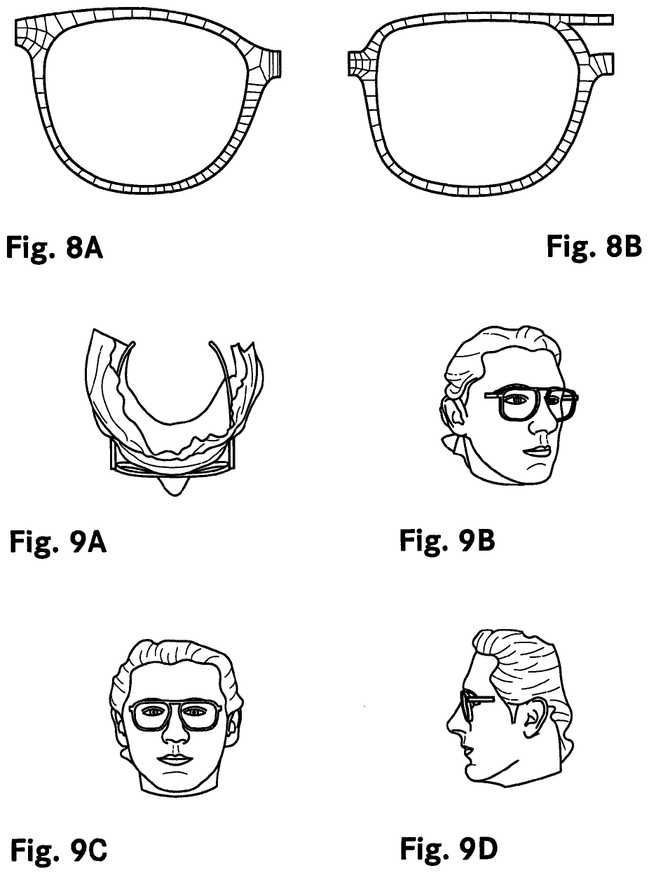

Two basic topologies are sufficient for the base models that are provided within the framework of the system shown, that is for pairs of spectacles with a single bridge (FIG. 8A) and for pairs of spectacles with a double bridge (FIG. 8B). The polygon mesh topologies are optimized in such a way that they comprise the minimum number of points, edges, and faces needed so as to be able to represent all the base models and to cover all the deformations needed in the adaptation process. The base models comprise data fields that represent relevant properties of the base model, for example the presence or absence of a double bridge, and the groups and attributes related thereto.

Further basic topologies may readily be provided in order to parameterize further models. A conversion module may be provided so that, even if adaptations have already been made in the selection process, the customer can still switch between models with different basic topologies without having to go through the adaptation process all over again. In this case, the conversion module can calculate and/or interpolate the parameter values that are not directly defined in the new polygon model.

On the basis of the orientation points and in accordance with firmly defined rules and parameter priorities, an initial parameter configuration is generated in an automated manner. For example, the width of the nose bridge of the pair of spectacles is determined on the basis of the width of the scanned nose, and the length of the temple is calculated on the basis of the distance from the root of the nose to the beginning of the auricle.

The initial parameter configuration refers to an initial model with a minimum number of polygon mesh elements to represent the respective spectacles shape. It defines the polygon mesh geometry for the subsequent adaptation process and contains all of the data required on the elements of the mesh.

Before the actual adaptation process, the corresponding polygon model (control polygon model) is first loaded into the working memory of the executing system. Subsequently, a pre-processing is carried out with regard to the adaptation, preview and generation of the production data. The results of this pre-processing are stored in such a way that they can be retrieved with the least possible computational effort and within the shortest possible time. In addition, more computationally intensive procedures of the adaptation component are—as far as possible—already carried out now, so that subsequently, during the actual adaptation, real-time operation is ensured even with moderate computing power. The pre-processing (step 17) includes, for example, the creation of a geometry for the rounding of edges for the nose pads or the shaped lens disc (see below). Several pre-processed objects are kept in parallel in the working memory and are retrieved as needed during the adaptation process.

A cyclic process now follows, which ultimately leads to a parameterized model for the spectacles frame that corresponds to the customer's wishes.

A machine learning algorithm is applied to the existing data, in particular the parameters mentioned and the three-dimensional image including orientation points (step 18). This provides adaptation values for the subsequent parameter adaptation (step 20) in the adaptation module 120, which is described in detail further below.

The machine learning algorithm was trained using existing 3D scans and associated, previously fitted made to measure glasses. The training data is augmented with each newly adapted model, and the data of the ML algorithm are periodically updated. In particular, with the aid of the machine learning algorithm, the orientation points are correlated with the parameters of the made to measure spectacles, i.e., the trained can predict parameters for the configuration of the made to measure spectacles on the basis of the orientation points of the face. Through this process, information and statistics relating to the parameters of the made to measure spectacles and the corresponding wearers can also be obtained, which provide an insight into the adaptation requirements of the wearer in terms of their age, gender, ethnic origin, etc. . . . . This information can then be used for the design of future spectacles for specific target groups.

After the parameters have been adjusted, which results in a modified model of the spectacles frame, this modified model—superimposed with the image data that show the head of the customer—is displayed. For this purpose, the polygon mesh of the adapted model is first refined by the transformation module 122 by a Catmull-Clark subdivision algorithm (step 21). The image data of the head are superimposed on this refined polygon mesh in the image output module 125 of the server 100, and transmitted via the data network to the optician's computer 200. There, the image can be displayed on the screen 202 (virtual try-on), see FIGS. 9A-D (step 22). The customer thus receives an impression of the fit and the aesthetic effect of the future pair of spectacles. Since the image data are available in three-dimensional form (and since they are provided with orientation points), the angle of view of the image can be changed without difficulty so that the aesthetic effect can be fully appreciated. In addition to the spectacles frame, the spectacle lenses with the corresponding reflections or even the influence of the optical power can also be displayed.

Several parameter configurations can be provided so that different models and/or adaptations can be directly compared with each other. The adaptation process can be carried out in a fraction of a second using the method in accordance with the invention, as a result of which it is possible to work with the system in real time. Since all base models go through the same parameterization and adaptation process, the base model can be exchanged if the parameters of the made to measure spectacles remain the same, resulting in a new, adapted spectacles model with the same made to measure spectacles parameters. By this, it becomes possible to quickly simulate several custom-fit spectacles on the basis of the customer data, and to try them on virtually.

The display can be done on the 3D model or can be superimposed on a live video stream of the customer. In the latter case, the same orientation points or a subset thereof are determined from the video data in real time, so that the virtual spectacles frame can be positioned correctly and immediately follow the movement of the head or a different viewing angle that has been chosen. The front camera of a tablet computer or of a smartphone may be used to capture the live video stream. In a corresponding manner, the displaying of the spectacles frame may be supported by existing “augmented reality” functions of this local terminal device.

The customer or a consulting specialist of the optician can now provide feedback on the current model with the aid of the keyboard 201 (and/or other input devices) (step 24). If further adaptations are required, these can be specified to a certain extent (for example by operating sliders for the lens size, the width of the bridge or of the lens rim in different areas, or by selecting a different type of spectacles model from a list). In a next step of the adaptation process, the new input data are processed together with the data already previously acquired (as far as these are not overwritten or replaced by the new data), i.e. first the machine learning algorithm is applied again (step 18), thereafter the further steps described follow.

If, after displaying the superimposed image, no further adaptations are necessary and the customer and/or their consulting service provider provisionally accepts the current model (decision 26), manufacturing data for a test copy are provided in the processing module 130 and transmitted to the optician's computer 200.

This includes the generation of a tag, as it is referred to, that is an element that is also manufactured during the course of the production process and which assigns, to the pair of spectacles, its unique identification. In addition, the shaped lens is made for each pair of spectacles. Further, a clip-on, as it is referred to, can be generated on request, that is a surface that fits frontally on the front of the pair of spectacles and has the same lens openings. The clip-on is provided with darkening sunshade lenses and can later be snapped onto the pair of spectacles by hooks. The shaped lens, the clip-on as well as the tag are attached to the pair of spectacles during the course of the manufacture by an eyelet. In addition, the unique identification is projected into the temples in the form of three-dimensional geometry. Likewise, the cavities for the hinges are projected into the temples and the front of the glasses, whereby, usually, additional polygon mesh elements are created. Similarly, the density of the polygon mesh is now increased again by the Catmull-Clark subdivision algorithm, whereby the data already existing for the display can be used as a point of departure, which data are further refined with a further iteration (step 27). As a result, the surfaces of the pair of spectacles are smoothed. Thus, it is only at this stage that the mesh topology is changed.

There, the test copy is produced with the local 3D printer 220 within a few minutes (step 28). This is a copy of the spectacles frame with the exact geometry, but without surface finishing and possibly made of a different material.

After the test copy has been tried on, the customer or the attending specialist can again provide feedback as to whether the model fits or whether further adaptations are still necessary (step 30). In the second case (decision 32), this new information is again fed back into the cyclic process, which is followed by the next step of applying the machine learning algorithm (step 18)—again applied to the polygon model without smoothing, i.e. with the polygon model of lower density. In the first case, an assignment step (step 34) is now carried out in the processing module 130, whereby all elements of the modeled spectacles frame are assigned to a material and a manufacturing process. Accordingly, different sets of manufacturing data are generated (step 36), again including the generation of the tag and other elements, as well as a preceding smoothing using Catmull-Clark subdivision (step 35). From this and from the optical data for the spectacle lenses which have already been entered beforehand by the optician, the necessary work for the manufacture of the complete pair of spectacles is obtained as a result.

Accordingly, an auctioning process (step 38) now takes place, whereby the server 100, via corresponding software interfaces (API), contacts computers of the manufacturers 310.1, 310.2, 310.3 of the first group for additive manufacturing of the spectacles frame, computers of the manufacturers 320.1, 320.2, 320.3 of the second group for grinding the spectacle lenses, computers of the manufacturers 330.1, 330.2, 330.3 of the third group for manufacturing further elements (in particular hinges, separate metal webs with silicone nose pads for attachment to the nose bridge, etc.) and computers of the service providers 340.1, 340.2, 340.3 for assembling the components and carries out a service provision auction (reverse auction) in order to generate several offers with different weightings (in particular with regard to the manufacturing time and the manufacturing price).

The customer can now select—again via the optician's computer 200—the preferred offer (step 40). Subsequently, the manufacturing data for the lenses are issued to the corresponding manufacturer 320.1 (step 42), and the manufacturing data for the spectacles frame (front of the pair of spectacles, temples) as well as for the other components (hinges, etc.) and the order for the assembly with the necessary details are transmitted to the corresponding manufacturers 310.1, 330.1 and service providers 340.1, respectively (step 44).

For the additive or subtractive manufacturing, the system in accordance with the invention can store the 3D polygon model in formats that are typical in the industry for storing polygon meshes such as STL, OBJ, PLY, for example. In addition, the system can however also generate and export spline curves and spline surfaces from the polygon model that are suitable for production systems that require such representation models for objects. Further, in addition to the representation of the 3D model, it is also possible to directly output instruction data sets for the production of the 3D model, that is, in the case of controlling 3D printers or milling machines, G-code that is generated in a machine-specific manner. For the production of the lens disks, the system can output standardized OMA data for the control of lens grinding machines. The various export options make it possible to manufacture pairs of spectacles in different materials that require different production processes and therefore different data exchange formats.

As a rule, the manufacturing data are encrypted and are provided with an access restriction. In this way it can be ensured, on the one hand, that no unauthorized third parties can use this data, and on the other hand, a remuneration model can be established in which the individual manufacturing processes of the same spectacles frame are invoiced individually.

In everyday life, it can happen that, for example, the optician needs information regarding the production of spectacles, which needs to be available in the form of physical objects instead of digital data. One such example is the shape of the lens disc, which an optician sometimes cannot transmit to a grinding machine in digital form because the shape needs to be sampled by the machine from a physical object. For such purposes, the system supports the ability to issue a physical template, such as a shaped lens disc, that is produced as part of the production process. In addition, dimensioned technical drawings can automatically be output by the system that document the adaptation process and that support the production process.

The manufacturers 310.1, 320.1, 330.1 produce the components ordered, if necessary with processes which are downstream to the actual production, such as dyeing, grinding or coating, and send them to the service provider 340.1. There, they are assembled and finally sent to the optician. There, the finished pair of spectacles can then be tried on. As they were produced in a made to measure way on the basis of the 3D measurement, there is, as a rule, no need for any further adaptation. At most, common adaptation steps (for example with regard to the shape of the temples) are still carried out by the optician. In addition, the corrective properties of the lens glasses in relation to the customer's eyes are checked.

The data exchange can be carried out entirely via a platform operated by the service provider on the server 100, which can be accessed by all parties involved (co-workers of the service provider, customer, optician, manufacturer, assembly service provider, logistics company, etc.). In each case, only the data that the respective party requires are enabled for read or write access. The access can take place via APIs, applications (apps) or Internet browsers, for example. The data can be made available via a blockchain infrastructure.

In principle, the platform also enables access at a later point in time, so that, if a pair of spectacles is lost or damaged, the required components can be reordered in an automated manner.

Unique details for identification are assigned to each order (and the resulting subordinate orders). The physically manufactured components are marked with these details, for example by an appropriate engraving, printing thereon, a machine-readable tag (RFID tag) or a label.

The parameter adaptation (step 20) mentioned above is described below. The adaptation process is performed by a sequence of defined functions that calculate the deformation of the spectacles model for a particular parameter change. The polygon mesh topologies are defined in such a way that the same adaptation steps are performed for all base models, although the adaptation functions may have a different effect in dependence upon the basic topology of the model. For this purpose, the corresponding data fields of the model are evaluated. For example, in case a double web is present, certain functions may provide for additional deformations in the region of the double web. All functions carry out their calculations on the basis of the control polygon mesh in a data-driven manner. In this context, the functions react on the one hand to the attributes of the individual polygon mesh elements and on the other hand to the parameters which are passed to the system from outside by an actor. This actor can be either a human or a machine—for example a machine learning model.

In order to calculate the deformation, the position of the elements of the polygon mesh is read, is deformed by a function and is then stored again. In order to calculate the respective deformation, the attributes stored per polygon mesh element (point, edge, polygon face) are taken into account. To ensure that the process for the actual adaptation of a pair of made to measure spectacles is capable for a real-time application, no generation of additional polygon mesh elements takes place during the adaptation process of the pair of spectacles. The adaptation process is carried out exclusively by deformation. Only for the generation of the manufacturing data is the density of the polygon mesh increased—as is described further below. In addition, the operations on the polygon mesh elements are parallelized on multiple computational cores, which significantly speeds up the computation.

All of the parameters discussed below—except for the inclination and certain dimensions of the temple—are relative values in millimeters and angle (degrees), which are based on the model dimensions of standard spectacles models. Of course, it is not necessary for the parameters of the polygon model to change in each of the steps. The corresponding adaptation value can be zero.

The mesh topology of the polygon model is adapted to the procedures described below that deform or modify the topology (creating new components of the design). Conversely, procedures that act on specific regions of the object expect these regions to have a specific mesh topology structure.

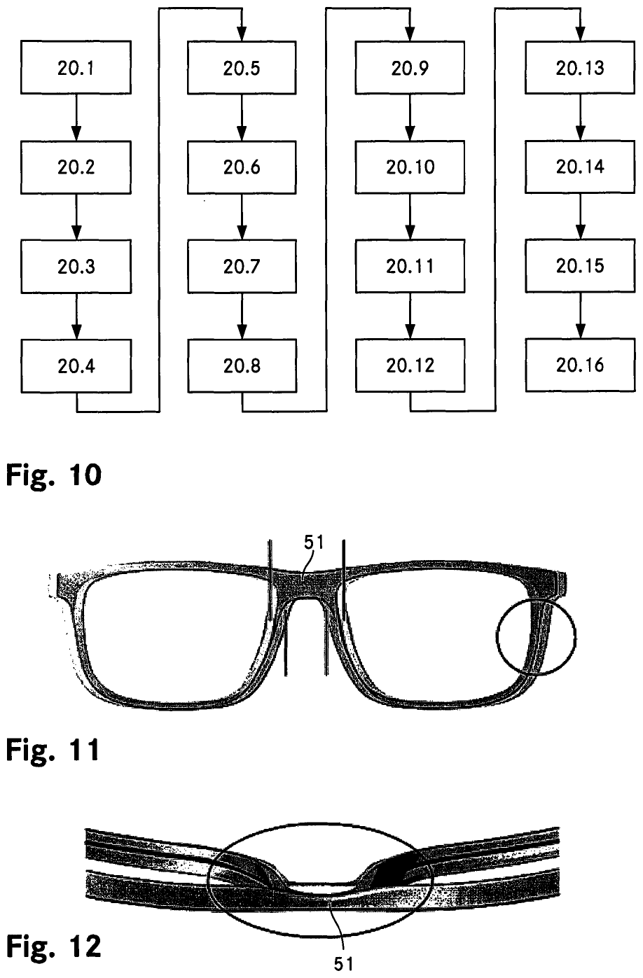

The flow of the parameter matching process is schematically illustrated in the flowchart in accordance with FIG. 10. First, in the step 20.1, the width of the bridge is adapted (FIG. 11). In this context, the width of the nose bridge 51 is increased or decreased. The thickness of the frame 50 does not change in the course of this. The total width of the front of the frame is increased or decreased by the amount of the change of the nose bridge 51.

In the next step 20.2, the depth of the nose bridge 51 is increased or decreased (FIG. 12). In the course of this, the remaining thickness of the frame is not changed.

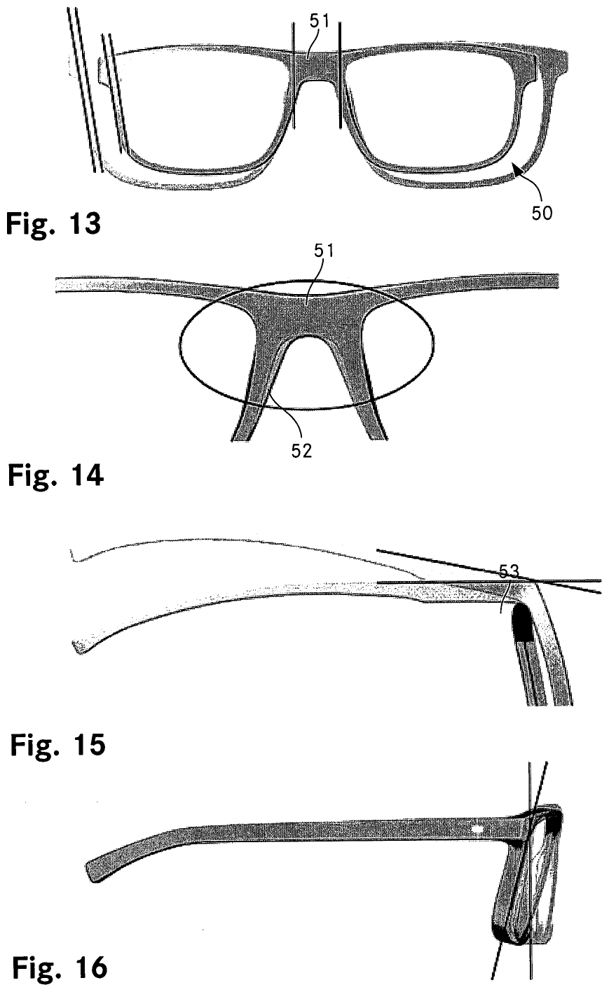

Next, the width of the lens is increased or decreased (step 20.3; FIG. 13). The entire front of the pair of spectacles adjusts itself accordingly. In this context, the lens height is adjusted in proportion to the lens width. The width of the nose bridge 51 does not change, the design of the pair of spectacles remains the same. In addition, the thickness of the frame 50 can optionally be changed in depth.

In the following step 20.4, the width of the nose bridge 51 is separately increased or decreased in the lower part (FIG. 14). As a result of this, the angle of the nose pads 52 changes. The overall width of the nose bridge 51 remains unchanged and the width of the front of the frame does not change as a result of this.

In a subsequent step 20.5, the upper inner portion of the lens opening of the frame 50 may be pulled down by 1 mm. This is necessary for some shapes for a better fit of the lens in the frame.

The radius of the shaped lens mentioned above (or shaped lens disc, the template which is used to copy the shape of the glass for cutting the corrective lens) may be increased in a next step 20.6. Some shapes require an increase in the shaped lens radius so that the corrective lens, which is created on the basis of the shaped lens template, fits more tightly in the spectacles frame.

In the next step 20.7 the base curve can be increased or decreased. The base curve corresponds to a projection of the spectacles frame onto a sphere with defined radii for the different base curves. The center of the sphere onto which the projection is made is positioned at the optical center of the glass lens. From this position, the center of the base curve sphere is tilted 6° towards the Z-axis and 9.5° towards the Y-axis. This gives the pair of spectacles a standard inclination of 9.5°. The thickness of the spectacles frame remains the same. Likewise, the width of the spectacles frame remains the same since the projection is realized by shearing the shape in depth onto the sphere.

The lens groove that secures the corrective lens in the spectacles frame may also be adapted (step 20.8). The groove may have either a round or a pointed geometry. Further, the depth of the groove can be determined.

In the next step 20.9, the angle of the temple with respect to the front of the pair of spectacles is increased (FIG. 15). In this context, only the end piece 53 of the spectacles frame is changed. The front of the spectacles frame remains unchanged.

Now the inclination is increased or decreased (step 20.10). In this context, the front of the spectacles frame is pivoted about a point on the end piece 53 of the spectacles frame (FIG. 16). The temples of the spectacles are not changed by this.

With the subsequent step 20.11, the curvature of the spectacles frame can be increased in the lower frame region from the nose bridge to the end piece of the pair of spectacles. This is necessary for the stability of certain models of spectacles.

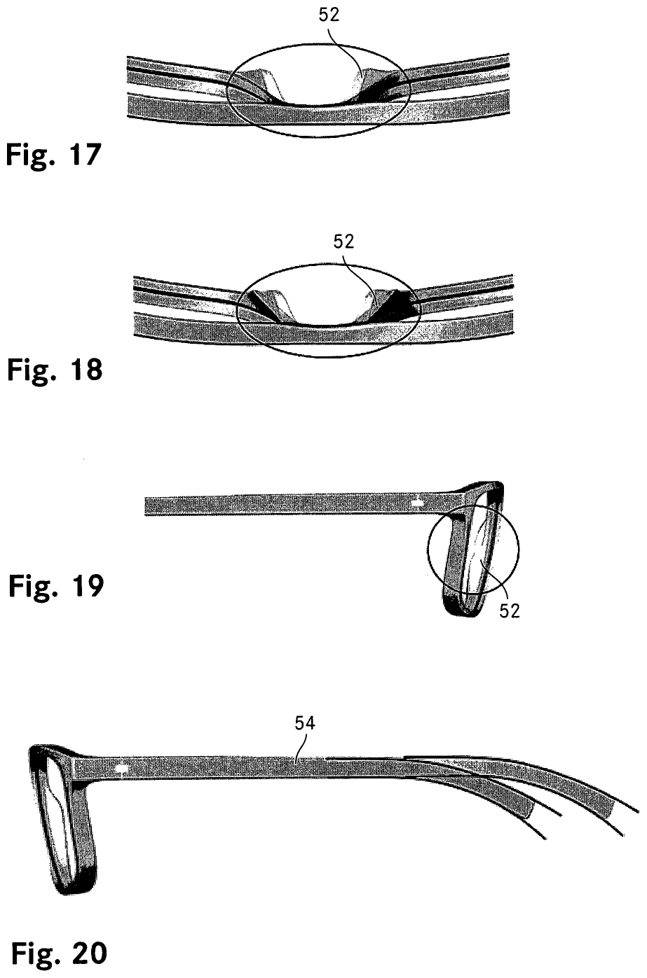

The subsequent step 20.12 allows the nose pads 52 to be modified in their height, depth and angle (FIGS. 17-19). All other dimensions of the spectacles frame are not affected by this. The nose pads 52 may also be modified in such a way that there is no longer a pad on the frame. In this case, holes are provided in the lower region of the nose bridge 51 to allow metal webs with silicone nose pads to be attached after production, as is common in traditional production of pairs of spectacles and as is requested by some customers.

In the next step 20.13, the length of the temple 54 can be increased or decreased (FIG. 20). The rim of the spectacles remains unaffected by this.

The temple 54 can be bent at the temple tip. For this purpose, the position of the bend of the temple, the angle of the bend of the temple and the radius of the bend of the temple can be influenced in the step 20.14. The spectacles rim is not affected by this.

Further functions are possible—depending on the base model—for example, the torsion of the end piece can be changed within the framework of a further step.

The functions are defined in such a way that, when they are used, the visual character of the pair of spectacles is preserved as far as possible. This means that, among other things, proportions of the individual regions of the pair of spectacles and the curvature of the guide curves are preserved as far as possible. This is realized by the attribute data of the polygon mesh, for example by the guide curves and points of reference being analyzed prior to the deformation, which, in turn, influences the mutual dependence of individual partial regions of a model of a pair of spectacles during the deformation.

Following on from the steps 20.1 . . . 20.14 mentioned above, the edges of the pair of spectacles are rounded (step 20.15). The rounding takes place in dependence upon the angle of the surfaces that are adjacent to the edges to be rounded.

Then, in the step 20.16, the spectacles model is positioned in such a way that the base of the columella is positioned at the coordinate origin of the global coordinate system (cf. above and FIG. 5B). Due to the preceding parameter adaptations, it may be necessary to adjust this positioning.

The parameters and deformation functions for the adaptation of a made to measure pair of spectacles mentioned above are designed in such a way that the frame can be adapted without the design of the shape being changed noticeably (a round pair of spectacles remains round and does not become oval etc. . . . ). All the important proportions of the spectacles model are maintained and regions such as the end piece of the pair of spectacles remain unchanged despite the transformation.

In addition, the process mentioned above is optimized for the production using materials with homogeneous material properties. This means, for example, 3D printing using one material.

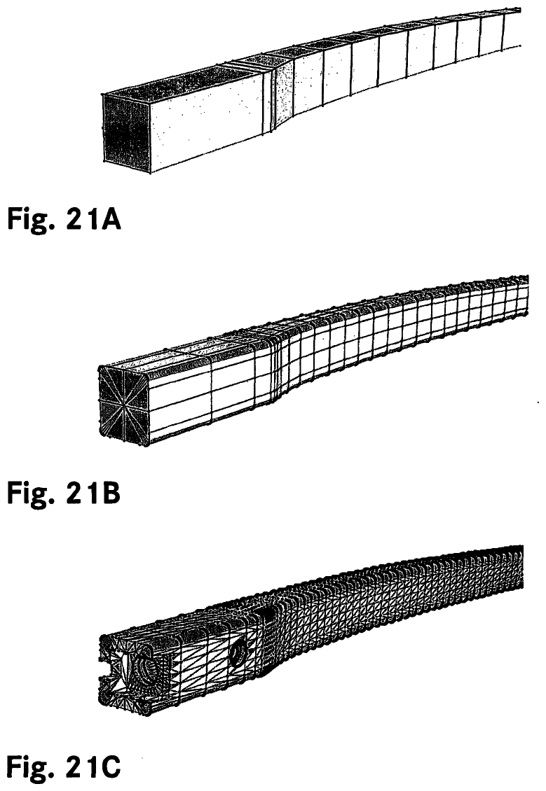

FIGS. 21 A-C are representations of a portion of the temple of the pair of spectacles adjacent to the front of the pair of spectacles. FIG. 21 A shows the original polygon mesh that is used within the framework of the adaptation process (polygon mesh of the control polygon model); FIG. 21 B shows a refined polygon mesh for display, and FIG. 21 C shows a further refined and further processed polygon mesh for additive manufacturing.

The refined polygon mesh in accordance with FIG. 21 B is obtained by applying the Catmull-Clark subdivision algorithm to the original polygon mesh multiple times. Its surfaces count is approximately four times larger than that of the original mesh. The resulting resolution is sufficient for the graphical representation of the glasses in a manner which is virtually as realistic as a photograph.

The further refined polygon mesh in accordance with FIG. 21 C is obtained by again applying the Catmull-Clark subdivision algorithm to the refined polygon mesh in accordance with FIG. 21 B. Its surfaces count is approximately 16 times larger than that of the original mesh. After the second iteration of the subdivision, openings (openings completely passing through the material, as well as blind holes) with a predetermined geometry were inserted into the polygon mesh for the additive manufacturing. They serve to accommodate a hinge element and other fastening elements.

The invention is not limited to the illustrated embodiment. Thus, the process on the customer side does not necessarily have to take place at an optician's or other skilled person's premises, but can take place at the customer's home or on the go using already existing terminal devices without any problems. A consultant (for example, an optician or a co-worker of the service provider) can be connected via video chat.

In like manner, the computers and manufacturing devices can also be located in various places. For example, a 3D printer at the optician's premises (or at the customer's home) is not mandatory. Instead of this, it is also possible within the framework of the method in accordance with the invention to use a 3D printer located close to the customer for manufacturing the end product. For example, this can be located, together with an automatic grinding machine, on the premises of the optician, so that the components can be manufactured directly at the optician's premises and assembled by the optician to form the finished pair of spectacles. In this context, additional elements can be used which do not have to be manufactured individually but are kept in stock at the optician's premises (for example hinge parts).

The distribution of processing tasks among the various computers may be different from that in the example embodiment. Thus, for example, the terminal device by which the 3D scan is performed may also already carry out initial processing steps, possibly including the assignment of the orientation points. The same applies to the terminal device on which the superimposed view of the spectacles model with the head of the customer is displayed (which may again be the same terminal device on which, for example, a dedicated application for interaction with the server is running). In another variant embodiment, all computational steps may be carried out on the server, so that the local terminal devices serve only for the acquisition and display of data (for example, via a browser interface).

The method of manufacture in accordance with the invention can also be used independently of a 3D scan. In principle, the base models of pairs of spectacles can be adapted on the basis of measurement data which are, for example, acquired and entered into the system by an optician. While the virtual fitting is omitted in this variant, the machine learning algorithm can readily be applied in this variant as well if a correspondence can be established between the input data of the ML algorithm (for example, the position of the orientation points) and the measurement data of the optician.

The adaptation process can also be designed differently. For example, it may be useful to provide additional deformation options for other base models of pairs of spectacles, in particular also those that change the actual shape. Further, additional procedures for automatically smoothing, distributing, and aligning an existing polygon topology can be provided and carried out as needed.

Individual input data which, in the example embodiment illustrated, result from automatic processes may also be manually entered by the end customer, an optician, or an operator on the service provider side. Conversely, it is possible to obtain, from additional automatic processes, certain input data that are collected manually in the example embodiment.

In addition, as has already been mentioned above, the system is in principle also suitable for 3D manufacturing processes in which two or more different materials are processed at the same time. The assignment takes place during the corresponding process step by making an assignment to a sub-process in addition to the assignment to a production method. This enables the production of one-piece objects that have heterogeneous material properties, i.e. material properties that change in a continuous manner. By this, it is in principle possible to realize, for example, hinge solutions not only on a geometric basis, but by the distribution of material in the object.

Various embodiments of the method in accordance with the invention have been explained above with reference to the design and manufacture of spectacles frames. The corresponding method steps and considerations can be transferred to the design and manufacture of other types of objects within the framework of what has been said above.

In summary, it is to be noted that the invention provides a method of generating geometric data of a personalized object, which enables the simple creation of new designs of the personalized object which can be adapted in a flexible manner through the use of parameters.

The embodiments described above are only descriptions of preferred embodiments of the present invention, and are not intended to limit the scope of the present invention. Various variations and modifications can be made to the technical solution of the present invention by those of ordinary skill in the art, without departing from the design of the present invention. The variations and modifications should all fall within the claimed scope defined by the claims of the present invention.

What is claimed is:

1.-20. (canceled)

21. A method for generating geometric data of a personalized object, the method comprising:
(a) providing a polygon model for the object, the polygon model comprising a mesh formed from mesh elements, the mesh elements comprising discrete points, edges and faces which represent an initial geometric shape of the object; wherein the polygon model comprises local attributes which are associated with to at least some of the mesh elements and relate to at least one association with one of a plurality of adaptation groups or parameters for a deformation process;
(b) providing a set of predefined adaptation tools for deforming a region of the mesh of the polygon model, the adaptation tools being defined in such a way that when the adaptation tools are applied to the mesh, a topology of the mesh is preserved, and that when the adaptation tools are used, the local attributes of the mesh elements of the region are evaluated to determine a measure of local deformation; and
(c) adjusting the polygon model by applying the adaptation tools.

22. The method of claim 21, wherein step (a) further comprises:
(a1) providing a basic polygon model for an object type of the personalized object, wherein local attributes are assigned to at least some mesh elements of the basic polygon model, which local attributes are indicative of an association with one of a plurality of adaptation groups;
(a2) providing the set of predefined adaptation tools associated with the basic polygon model for deforming the polygon model derived from the basic polygon model, wherein the adaptation tools are adapted to the object type and at least some of the adaptation tools evaluate the local attributes during their application, which local attributes are indicative of the association with the adaptation groups; and
(a3) modeling the basic polygon model in order to obtain the polygon model, wherein a topology of the basic polygon model remains unchanged, wherein the local attributes are modified as needed, wherein a set and definition of the plurality of adaptation groups is maintained.

23. The method of claim 21, wherein step (c) is carried out in a fully automated manner, based on input data.

24. The method of claim 23, wherein the input data comprises processing data which are obtained from a geometry information about a counterpart of the object.

25. The method of claim 24, wherein the geometry information is obtained from a three-dimensional image of a region of a person's body.

26. The method of claim 24, wherein the processing data are obtained from the geometry information by means of a process which is based on machine learning.

27. The method of claim 26, wherein the machine learning is based on a multitude of training data from three-dimensional images of a multitude of persons and adapted polygon models associated therewith.

28. The method of claim 27, wherein the machine learning is further based on data relating to properties of the person.

29. The method of claim 21, wherein the association with the adaptation group is indicative of an association with a spatial region of the polygon model.

30. The method of claim 21, wherein the association with the adaptation group is indicative of an association with a guide curve of the polygon model.

31. The method of claim 21, wherein the association with the adaptation group is indicative of a point of reference of the polygon model.

32. The method of claim 21, wherein the parameter for the deformation process specifies a radius for a rounding of an edge or a deformation weight.

33. The method of claim 21, wherein the set of predefined adaptation tools comprises at least one local adaptation tool, which when applied to the polygon model, controlled by the local attributes, has an influence only on a local region of the model, whilst leaving all regions outside this local region unaffected.

34. The method of claim 21, wherein at least one of the adaptation tools determines an extent of a deformation based on a local attribute of mesh elements affected.

35. The method of claim 34, wherein the at least one adaptation tool restricts a maximum deformation for mesh elements which belong to a guide curve of the polygon model or which form a point of reference of the polygon model.

36. The method of claim 21, wherein the local attributes that are assigned to a mesh element of the polygon model are indicative of the association with a plurality of adaptation groups.

37. The method of claim 36, wherein, for a mesh element which is associated with a plurality of adaptation groups, an adaptation tool determines a first partial deformation based on an association with a first one of the adaptation groups and a second partial deformation based on an association with a second one of the adaptation groups, and a deformation applied to the mesh element is derived from the first partial deformation and the second partial deformation.

38. The method of claim 21, wherein a plurality of adaptation steps are carried out with the adaptation tools from the set of predefined adaptation tools in accordance with predetermined rules and with predetermined priorities.

39. The method of claim 22, wherein the generating geometric data of the personalized object includes for further processing into manufacturing data for the manufacture of the object,
wherein step (c) is carried out in a fully automated manner, based on input data;
wherein the input data comprises processing data which are obtained from a geometry information about a counterpart of the object;
wherein the geometry information is obtained from a three-dimensional image of a region of a person's body;
wherein the processing data are obtained from the geometry information by means of a process which is based on machine learning;
wherein the machine learning is based on a multitude of training data from three-dimensional images of a multitude of persons and adapted polygon models associated therewith;
wherein the machine learning is further based on data relating to properties of the person, including at least one of an age, a gender, an ethnic origin, and information relating to preferences of the person;
wherein the association with the adaptation group is indicative of an association with at least one of a spatial region, a guide curve, and a point of reference of the polygon model;
wherein the parameter for the deformation process specifies a radius for a rounding of an edge or a deformation weight;
wherein the set of predefined adaptation tools comprises at least one local adaptation tool, which when applied to the polygon model, controlled by the local attributes, has an influence only on a local region of the model, whilst leaving all regions outside this local region unaffected;
wherein at least one of the adaptation tools determines an extent of a deformation based on a local attribute of mesh elements affected;
wherein the at least one adaptation tool restricts a maximum deformation for mesh elements which belong to a guide curve of the polygon model or which form a point of reference of the polygon model;
wherein the local attributes that are assigned to a mesh element of the polygon model are indicative of the association with a plurality of spatial regions of the polygon model;
wherein, for a mesh element which is associated with a plurality of adaptation groups, an adaptation tool determines a first partial deformation based on an association with a first one of the adaptation groups and a second partial deformation based on an association with a second one of the adaptation groups, and a deformation applied to the mesh element is derived from the first partial deformation and the second partial deformation; and
wherein a plurality of adaptation steps are carried out with the adaptation tools from the set of predefined adaptation tools in accordance with predetermined rules and with predetermined priorities.

40. A computer program which is adapted to cause a computer processor to perform a method comprising:
(a) providing a polygon model for an object, the polygon model comprising a mesh formed from mesh elements, the mesh elements comprising discrete points, edges and faces which represent an initial geometric shape of the object; wherein the polygon model comprises local attributes which are associated with at least some of the mesh elements and relate to at least one association with one of a plurality of adaptation groups or parameters for a deformation process;
(b) providing a set of predefined adaptation tools for deforming a region of the mesh of the polygon model, the adaptation tools being defined in such a way that when the adaptation tools are applied to the mesh, a topology of the mesh is preserved, and that when the adaptation tools are used, the local attributes of the mesh elements of the region are evaluated to determine a measure of local deformation; and
(c) adjusting the polygon model by applying the adaptation tools.
